(19) United States
(12) Patent Application Publication
(10) Pub. No.: US 2006/0074696 A1
(43) Pub. Date: Apr. 6, 2006

(54) Information processing device, information processing method, information processing program and medium

(75) Inventor: Koji Sato, Soraku-gun (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 10/531,209

(22) PCT Filed: Oct. 10, 2003
(86) PCT No.: PCT/JP03/13091

§ 371 Date: Apr. 14, 2005

(30) Foreign Application Priority Data
Oct. 15, 2002 (JP) 2002-300645

(51) Int. Cl. G06Q 99/00

(52) U.S. Cl. 705/1

(57) ABSTRACT

An information processing apparatus includes a determining portion for performing, on an object of which element or procedure can be described based at least on information related to time, a process based on time information for determining an element or procedure of said object, an executing portion for executing a process based on contents of the process determined by the determining portion; and an object management portion storing the object for managing its operation and status. The object reflects a result of execution or decision of a process based on the time information to an element or procedure of the object or on the object itself.

### TECHNICAL FIELD

The present invention relates to apparatus and method of information processing, an information processing method and medium, related to an object of which property can be changed by a process based on time information.

### BACKGROUND ART

Recent expansion and penetration of network technique have made it more and more common that data or service accessible on a network can be used ubiquitously, that is, at any place or space. In such situations, there is an increasing need for situation-oriented processing.

In a conventional processing model, processes which are implemented under a specific condition have been defined respectively, while increasing ubiquitousness of computer resources forces a shift to a network model, leading to the necessity mentioned above. As a result, there arises a problem as to what method is effective to connect resources dispersed on the network to improve convenience for the user.

One possible resolution to realize the situation-oriented processing is a time-based approach.

By way of example, assume that processes among multimedia objects are to be realized in synchronization, or processes on such media as images and sounds are to be varied dependent on the time of activating applications. Introducing the concept of time is an important element to realize such operations.

Essential points here are how to introduce the concept of time to the process model and how to realize coordination among processing units as the objects.

In the approach as to the former point of how to introduce the concept of time, by an introduction of a time attribute to a conventional information processing model, there consolidates a provision of a model which can increase the number of dimensions of data and can be handled data with time-axis. Here, the main focus is on a data model that can handle the concept of time, typically, on how to realize a single application seen in a time-constrained database, and there have been a number of practical applications thereof

The latter point, that is, how to realize coordination among processing units as the objects, leads to a problem of how to realize an open system in which data processing units with time concept are coordinated in a sort of autonomous manner. There has been no clear approach as to this point.

A conventional example of a model that performs time-dependent information processing is a graphical user interface (GUI) such as described in Japanese Patent Laying-Open No. 8-30427.

Here, time zone information representing a time zone in which an object is usable is stored, and a computer system compares the stored time zone information with the present time as a system status, to determine whether the object is usable or not. Using this, the technique disclosed in Patent Document 1 realizes a GUI apparatus that alleviates user's burden of unwanted input operations.

In the conventional example described above, what is done is simply to determine usability of a user interface (UI) object of interest and not to display the UI component when it is unusable.

In addition, the “time for determination” is simply referred to as a condition for determining the usability, and therefore, no consideration is taken on such a point as to how the process should be handled at a timing when an object that has been usable becomes unusable, while the process is executed continuously.

In the conventional example described above, presence/absence of a display of object is controlled, and therefore, there is expected an effect that an operation is inhibited as there is no display. A process dependent on simple turning on/off of a function, however, is not sufficient to realize a UI function that provides different contents of processing or different contents of services dependent on time.

In a small portable terminal having limited hardware resources such as a small image display area, it is a serious question how to realize efficient display and operations. Particularly, it is undesirable if a hardware resource such as a specific display area is occupied in a function-off state.

Further, it is often the case that a small portable terminal has a small display area, low resolution and limited number of usable buttons due to hardware constraint, or the number of UI components that can be displayed at one time is limited due to system constraint.

For the small portable terminal as such, it is effective in improving versatility of use to change processes assigned to UI or hardware buttons dependent on time. As an extreme example, assume that the available hardware resource is only an area or function corresponding to one button. Even in that case, if an optimal process is assigned to that button dependent on time, the contents of processing for key arrangements could be changed dependent on time, by way of example, when the portable telephone is used.

When processes assigned to hardware buttons are changed, there is an option that display itself is put off in the function-off state. In that case, however, it is necessary to provide complementary information to enable the user to identify whether the processing is impossible because of some malfunction or the use is prohibited by the system when the terminal is actually used, and such a function is practically indispensable.

In the conventional example described above, the only description is that object behavior is changed dependent on time, and the scope of expected processes does not extend further than that.

Generally, when a process of changing the contents to be displayed dependent on the present time is to be realized, it is necessary for a system designer to separately prepare programs that causes desired processes at desired time points. Therefore, it is difficult to realize a general scheme that enables change of processes dependent on time.

In other words, in a model having time constraint on procedure contents and method of display, and information processing is performed based thereon, a specific solution to realize coordination among objects is needed.

### DISCLOSURE OF THE INVENTION

An object of the present invention is to provide apparatus and method of information processing, an information processing program and medium that enable adaptive information processing of objects of which elements or procedures can be described at least based on time-related information, by changing the property thereof including display and meaning through processing based on the time information.

Another object of the present invention is to provide apparatus and method of information processing, an information processing program and medium that can realize a user interface capable of providing appropriate information to the user, by changing behavior including processing and meaning, through processing based on the time information.

According to an aspect, the present invention provides an information processing apparatus, including: determining means for performing, on an object of which element or procedure can be described based at least on information related to time, a process based on time information for determining an element or procedure of the object; executing means for executing a process based on contents of the process determined by the determining means; and object management means storing the object for managing its operation and status; wherein in the object to be processed by the information processing apparatus, different time-restricting condition may be imposed on every uniquely identifiable element or procedure defined in the object, and the determining means selects an appropriate process at a timing of applying the time information.

Preferably, the apparatus further includes event notification means registering and holding an event condition based on external information, for notifying the object management means about an event that occurs when the condition is satisfied; wherein the event notification means and the object management means each include interface means for performing an event input/output operation; and the executing means changes the process in an event-driven manner in response to the event input/output operation.

Preferably, the determining means has object generating means for newly generating, after determination of a process related to specific contents of the element or procedure of the object by applying time information an object based on the result of determination; and the executing means performs a process based on the generated object.

Preferably, in the object to be processed by the information processing apparatus, a plurality of contents of elements and procedures of the object are prepared, the plurality of contents of elements and procedures are fully contained in a single object, and the contents are selectively determined by processing the time information.

Preferably, in the object to be processed by the information processing apparatus, contents of an element or procedure of the object can be described in a form of external reference; and in determining contents of an element or procedure of an object, when any item requires external reference for solution, the determining means requests the object management means for the solution and determines the contents of processing.

Preferably, the object management means has storing means, searching means for searching for an object stored in a storage area of the storing means, and communication means for obtaining information through a network, and in response to a request from the determining means, searches and obtains necessary information under control or through the network, and notifies the determining means about the contents, whereby the item requiring external reference is solved and the contents of processing are determined.

Preferably, the object to be processed by the information processing apparatus has such a format of representation that a specific value or method related to its element or procedure is determined for the first time when the determining means applies the time information.

Preferably, when the determining means applies time of activation, the object to be processed by the information processing apparatus has a data value or method related to its element or procedure determined.

Preferably, when the determining means applies virtual time of activation, the object to be processed by the information processing apparatus has a data value or method related to its element or procedure, based on the condition, adapted and determined.

Preferably, the object to be processed by the information processing apparatus has contents of its element or procedure described in a form of a time-related function, and when the determining means applies the time information, a data value or method related to its element or procedure is determined. Preferably, in the object to be processed by the information processing apparatus, description simultaneously including descriptions based on a plurality of time constraints may be made as long as there is no time crossing, on every uniquely identifiable element or procedure defined in the object; and the determining means selects an appropriate process at a timing of applying the time information.

Preferably, time constraint related to an element or procedure defined in the object to be processed by the information processing apparatus is described as a condition of invalidating the corresponding element or procedure.

Preferably, in determining contents of an element or procedure related to the object to be processed, when there is no item that satisfies a time constraint, the determining means makes a notification to the object management means and any process related to the object thereafter is stopped.

Preferably, in determining contents of an element or procedure related to the object to be processed, when there is no item that satisfies a time related condition, the determining means makes a notification to the object management means and executes a process based on an object appropriately selected by the object management means.

Preferably, some of the time constraints imposed on the element or procedure defined in the object to be processed by the information processing apparatus may mixedly include descriptions in accordance with different time scale designations; and the determining means includes means for selecting an actual process by mapping time constraint scales imposed on the element or procedure of the object to a single time axis.

Preferably, some of the time constraints imposed on the element or procedure defined in the object to be processed by the information processing apparatus may mixedly include descriptions in accordance with different methods of designation including absolute time designation, relative time designation or interval designation; and the determining means includes means for selecting an actual process by using a predetermined priority with respect to descriptions of time constraints imposed on the element or procedure of the object.

Preferably, when the object to be processed by the information processing apparatus is generated from an arbitrary time-constrained object as a parent, the object inherits characteristics related to not only the element or procedure defined in the parent object but time-constrained conditions imposed on the element or procedure.

Preferably, the object to be processed by the information processing apparatus inherits each time constraint related to the element and procedure defined by the parent object, and when a process related to the corresponding element and procedure is to be overridden, asks the parent object for delegation of authority to obtain permission of execution.

Preferably, the object to be processed by the information processing apparatus individually inherits or refers to only the time constraint related to each of the element and procedure defined by the parent object, whereby a process dependent on a part of a process of the parent object is described.

Preferably, the object to be processed by the information processing apparatus asks the parent object for permission, when it individually inherits or refers to only the time constraint related to each of the element and procedure defined by the parent object, for a process in which the objects are highly dependent on each other.

Preferably, the object to be processed by the information processing apparatus adjusts a timing of linked processing among objects, by re-arranging, through an off-set designation, time constraints related to the element and procedure defined by the parent object.

Preferably, the executing means has information presenting means for presenting to the user, at a timing of switching of a process based on contents of an element or procedure of the object determined by the determining means, information related to a change in the process; and at a timing when object behavior changes with time, presents information related to the change in the object behavior to the user.

Preferably, the object management means registers a timing of determining contents of the element or procedure related to the object by the determining means in the event notification means beforehand, to perform scheduling of the timings of determining operations thereafter.

Preferably, the object management means has registering means for registering the timing of determining contents of the element or procedure related to the object by the determining means in the event notification means to cause event firing at a timing earlier than a defined time; and after receiving an event from the event notification means, earlier than a timing when contents of the element or procedure are changed by the determining means, information related to a change in behavior of the object is presented to the user.

Preferably, the object to be processed by the information processing apparatus realizes a user interface, and a method of displaying a component is changed in accordance with applied time information.

Preferably, the object to be processed by the information processing apparatus realizes a user interface, and a method of operation assigned to the component is changed in accordance with applied time information.

Preferably, the object to be processed by the information processing apparatus realizes a user interface, and at a timing when object behavior changes with time, the change in the object behavior is presented to the user by changing a component display through animation.

Preferably, the information processing apparatus includes means for performing information processing involving an object of which element or procedure can be described based on time information and an object not dependent on time information.

According to another aspect, the present invention provides an information processing method, including the steps of determining, on an object of which element or procedure can be described at least on information related to time, contents of the element or procedure of the object based on time information; performing information processing based on the determined contents of processing; and performing adaptive information processing, by storing the object, managing operation and status, and changing contents of the element or procedure described in the object based on the time information; wherein in the object to be processed by the information processing apparatus, different time-restricting condition may be imposed on every uniquely identifiable element or procedure defined in the object, and the determining step includes the step of selecting an appropriate process at a timing of applying the time information.

According to a further aspect, the present invention provides an information processing program, causing a computer to execute the steps of determining, on an object of which element or procedure can be described at least on information related to time, contents of the element or procedure of the object based on time information; performing information processing based on the determined contents of processing; and performing adaptive information processing, by storing the object, managing operation and status, and changing contents of the element or procedure described in the object based on the time information; wherein in the object to be processed by the information processing apparatus, different time-restricting condition may be imposed on every uniquely identifiable element or procedure defined in the object, and the determining step includes the step of selecting an appropriate process at a timing of applying the time information.

According to a still further aspect, the present invention provides a computer readable recording medium, recording an information processing program causing a computer to execute the steps of: determining, on an object of which element or procedure can be described at least on information related to time, contents of the element or procedure of the object based on time information; performing information processing based on the determined contents of processing; and performing adaptive information processing, by storing the object, managing operation and status, and changing contents of the element or procedure described in the object based on the time information; wherein in the object to be processed by said information processing apparatus different time-restricting condition may be imposed on every uniquely identifiable element or procedure defined in the object, and said determining step includes the step of selecting an appropriate process at a timing of applying the time information.

The apparatus and method of information processing, an information processing program and medium of the present invention realize adaptive information processing by changing, with time, property of an object that includes time information in the contents of its element or procedure.

In some embodiments, different time constraints may be set with various time scales and methods of designation mixed, on each of the contents of elements or procedures of the object to be processed, and hence, it becomes possible to realize the apparatus and method of information processing, an information processing program and medium that can describe flexible processing such as changing meaning of a procedure itself dependent on the time of object activation.

In some embodiments, processes under such different time constraints can be contained in a single object, and therefore, object processing based on time information becomes possible even in electric appliances for home use without any communication function.

In addition, in some embodiments, behavior of an object including time constraint information can be referred to or inherited by another object, and therefore, a dependent model in which behavior of a certain object depends on time constraint of another object, or a coordinated model among objects can be built systematically.

In some embodiments, it is possible to realize apparatus, method and medium of information processing that have, as an input source, virtual time information in addition to real time information, effectively improving convenience to contents/service developers in the process of debugging object processing.

In some embodiments, network services can be coordinated under time-constrained condition, making it possible to build systematic services including operation of the time-oriented services and an environment in which these services are coordinated with each other.

In addition, in some embodiments, an object is re-configured based on contents of an element or procedure selected as satisfying a time constraint, and the process proceeds using the object, whereby process overhead can be eliminated, and performance in executing a specific process can be improved.

In some embodiments, a processing system can be realized that mixedly includes an object of which property depends on time information and other object of a common object-oriented system.

Further, in some embodiments, the apparatus and method of information processing, information processing program and medium in accordance with the present invention realize information processing, in which the process for changing with time the property of an object including time information in its element or procedure contents, in an event-driven manner.

In some embodiments, by incorporating, as an input source, sensing information related to an aspect of use such as a user, application or terminal, information processing based on detailed services becomes possible.

Further, in some embodiments, a presentation type information processing can be realized, which notifies a user about a timing of change in contents of an element or procedure in a process related to an object.

In some embodiments, a timing of notifying change in contents of an element or procedure of an object is presented prior to the actual object processing, so that a display image or audio output can be provided as an advance notice of actual processing.

In addition, in some embodiments, when a UI component is realized as an object containing time information, not only a UI element of which display or procedure contents change with time can be realized but also a process that effectively presents the change to the user by, for example, inserting an animation processing, can be realized.

Further, in some embodiments, time-driven type UI component and UI system can be realized in which image display or procedure meaning is changed when a certain time arrives, as if it is changed automatically, without necessitating any explicit instruction or action by the user, by scheduling in advance a timing for determining object processing.

### BRIEF DESCRIPTION OF THE DRAWINGS

FIG. 1 is a schematic block diagram representing a configuration of an information processing apparatus 100 in accordance with the present invention.

FIG. 2 shows an example of a description of an object imposing time constraint.

FIG. 3 shows an example of a description of an object imposing different time constraints on each of object elements or procedures.

FIG. 4 shows an example of a description of an object where the object includes an external reference.

FIG. 5 is a flow chart representing an object processing algorithm related to a process performed by information processing apparatus 100 in accordance with the present invention.

FIG. 6 is an illustration showing a concept of applying different methods of designation such as absolute time designation and interval designation, together on one same item.

FIG. 7 is a flow chart representing a detailed algorithm of step S12 of FIG. 5.

FIG. 8 is a schematic block diagram representing a configuration of an information processing apparatus 200 in accordance with a second embodiment of the present invention.

FIG. 9 is a flow chart representing an event-driven algorithm performed by information processing apparatus 200.

FIG. 10 is a flow chart representing an event-driven algorithm followed by information processing apparatus 200 having such a configuration as shown in FIG. 8.

FIG. 11 is a functional block diagram related to a UI realized by an information processing apparatus 300 of the present invention.

FIG. 12 shows an application component in accordance with a third embodiment.

FIG. 13 is a flow chart representing a flow of a UI event processing in accordance with the third embodiment.

FIG. 14 is an illustration showing a concept that contents (picture) change dependent on activation time.

FIGS. 15A to 15C represent time-dependent functions when the process of FIG. 14 is realized.

FIGS. 16A to 16D represent exemplary displays of a network service.

FIGS. 17A and 17B represent exemplary displays of a network service.

FIG. 18 is a flow chart representing a detailed algorithm of step S19 of FIG. 5.

FIGS. 19A and 19B represent an exemplary application operating on a portable telephone.

FIGS. 20A and 20B represent an exemplary application operating on a portable telephone.

### BEST MODES FOR CARRYING OUT THE INVENTION

In the following, embodiments of the present invention will be described with reference to the figures. In the following description, same parts are denoted by the same reference characters. They have the same names and functions. Therefore, detailed descriptions thereof will not be repeated.

[First Embodiment]

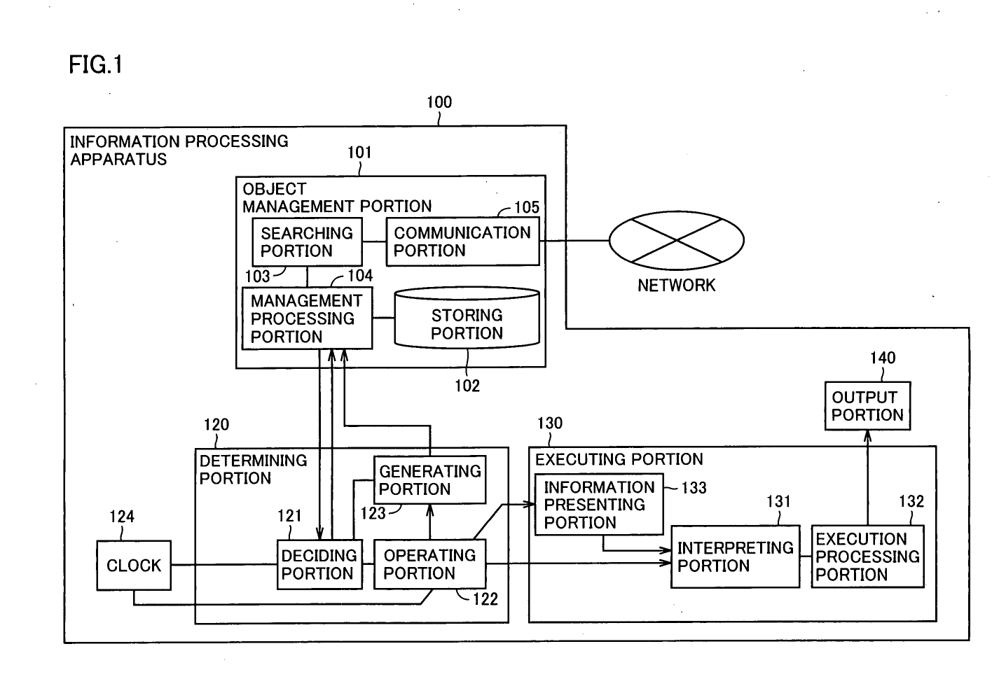

FIG. 1 is a schematic block diagram representing a configuration of an information processing apparatus 100 in accordance with the present invention.

Information processing apparatus 100 includes an object managing portion 101, a determining portion 120 and an executing portion 130, for realizing a process related to an object of which element or procedure can be described at least based on time-related information.

Each of these will be described in the following.

As to an “object”, that is, an object to be processed by information processing apparatus 100, an element or procedure of the object can be determined based on time information or information obtained by processing the time information, and the result of execution or determination based on the time information is reflected on the element or procedure of the object or reflected on the object itself.

Here, “time information” refers to information described in a format that can be identified by information processing apparatus 100. When it is used simply as additional information, it is applied in a format sparse from specific processes of internal elements or procedures as essential components generally defined as the object. By way of example, XML (extensible Markup Language) is used as a typical description method, and it is described as an attribute.

This does not apply when the time information is utilized as tight contents constituting the element or procedure. Such example includes 1) when a procedure related to the object is defined as a function, in which the time information is given as one variable, and 2) when the time information is deeply embedded in a procedure itself, for example, when a procedure to an element must be processed without fail within a definite time period, such as band guarantee.

Details of the object as an object to be processed by the invention will be described later.

Object managing portion 101 includes a storing portion 102 storing the above-described object itself or information related thereto in an internal database area, a searching portion 103 searching for an object matching a corresponding condition from the memory area, a management processing portion 104 managing operations and states of the object that is being executed at present, and a communication portion 105 for obtaining information on a network.

Here, object managing portion 101 functions as a main body that manages an object including the time information as described above and to administer selection/execution of an appropriate object in an executing stage.

At the time of executing a program, when the program is read from an external storage area (not shown) such as a hard disk (HD), flash memory or a memory card to a main storage, management processing portion 104 stores information for comprehensive management of the object as a component of the program in storing portion 102.

Storing portion 102 stores management information sufficient to be reflected to status management of the object, including a memory address and identification information (ID) of an object code existing on a physical memory, indexes to various internal data, status information of an element/procedure that is being selected and processes at present, and link information indicating dependency on other object.

The information stored in storing portion 102 is appropriately accessed by management processing portion 104, and necessary management information is referenced/updated as needed. Management processing portion 104 manages entire information related to the object, and stores necessary information using storing portion 102.

An object that becomes an object to be processed in the course of executing a program has its information transmitted 104 to determining portion 120 by management processing portion as needed, and the process is determined in following stages. In this sense, management processing portion 104 has a function of performing extraction of an object to be executed by the program and performing transmission to determining portion 120 at appropriate timings.

Searching portion 103 assumes a position of a higher order service than management processing portion 104, and is used when necessary information of an object is referred to in the object management information database (DB) stored in storing portion 102. If it is necessary to refer to another object or to switch to a process defined by another object while a process defined by an object is being executed, the object of interest is searched for by searching portion 103.

Searching portion 103 also has a function of searching for an effective object candidate under the time constraint applied as constrained condition, and extracts a related object. When there are a plurality of candidates satisfying the constrained condition, the candidates are ranked or extracted in accordance with a selection rule. An example of such selection rule is that extraction and ranking are done starting from one having higher dependency, such as in the case of parent-child relationship, on a certain object.

A rule set including a plurality of such selection rules differs dependent on a context of object processing, and therefore, it is important to allow external introduction thereof Thus, it is preferred that the rule set is introduced from the outside. However, the set may be given in advance, and the policy thereof is managed by management processing portion 104. Specifically, when management processing portion 104 searches for an object using searching portion 103, it is assumed that the rule for searching has already been given.

When an object having its information not stored in storing portion 102 is to be resolved, searching portion 103 searches for/retrieves the information of the object through a network using communication portion 105, and notifies management processing portion 104 about the retrieved information. The information collected by searching portion 103 using communication portion 105 is not necessary the object itself as the object of processing, and data in a broad sense may be the object of searching. That depends on how the information to be resolved by the description in the object is applied.

Management processing portion 104 refers to/extracts an object necessary for executing the program, and successively transmits the information thereof to determining portion 120, which will be described later. The information transmitted to a deciding portion 121 in determining portion 120 is a pointer to the object to be processed, and matters to be decided in the process that follows are handled by determining portion 120.

Determining portion 120 refers to the received object and, in addition, the time information associated with the component thereof upon instruction from object managing portion 101 and decides, to determine specific contents of a procedure or element of the object.

Determining portion 120 includes deciding portion 121 deciding time information to which specific contents of procedure or element of the object are associated and determining actual operation and behavior, an operating portion 122 establishing contents of a specific procedure from an output of deciding portion 121, and a generating portion 123 newly generating an object based on an output from deciding portion 121 or operation portion 122.

A clock 124 is connected to deciding portion 121 and operating portion 122. The time information given in relation to the element or procedure item of the object is processed by deciding portion 121 and as a result of this processing, or by direct comparison/collation with the time information, an appropriate process is selected.

When each element or procedure item of the object has a direct time setting, that is, time constraint, deciding portion 121 selects an item that satisfies the constrained condition, and outputs the result to operating portion 122.

When an object to be processed indirectly refers to time constraint of another object, for example, when the object inherits time constraint of another object, deciding portion 121 inquires of the management processing portion about the necessary time constraint of the object, and refers to the constrained condition to be satisfied. Thereafter, it selects an appropriate process. In this case, in order to resolve the time constraint of the object, it is possible that reference is made through a recursive procedure between deciding portion 121 and management processing portion 104.

Based on the input from deciding portion 121, operating portion 122 transmits a portion as an object of execution of the specifically established process to an executing portion 130, which will be described later. When a description related to an element or procedure constituting the object includes a time-dependent variable (time-variable object, described later), in addition to the process procedure selected by deciding portion 121, operating portion 122 applies the time information to the time-dependent variable portion using clock 124 to determine specific process as an object of execution, and transmits the same to executing portion 130.

Generating portion 123 re-configures an object from the specific contents to be processed of the element or procedure constituting the object selected by deciding portion 121 and operating portion 122. In this manner, an object as a sub-set for the original object is newly generated, information thereof is notified to management processing portion 104 in object managing portion 101, and the information is stored in storing portion 102, whereby execution performance for a specific process can effectively be improved. There is also an effect that the time information is adapted to the time-dependent variable portion using clock 124, whereby the object of which specific process to be processed is determined is secured in the area, and hence, more efficient use of the object eliminating the process overhead can also be attained.

The object re-configured by generating portion 123 must maintain the information with respect to the relationship to the original object. Therefore, generating portion 123 transmits the information necessary for the management thereof to management processing portion 104 in object managing portion 101. Specifically, the “information necessary for the management” includes a memory address of the newly formed object code, an ID of the original object to be referred to, an index to internal structural data indicating which element or procedure is being selected, application time and so on.

Based on the new object generation information from generating portion 123, management processing portion 104 integrates such information in object managing portion 101 and manages the same to be used as a cache of the object.

After the process for the element or procedure described in the object of interest is selected or determined, deciding portion 121 feeds back the information related thereto to management processing portion 104 in object managing portion 101. Accordingly, management processing portion 104 in object managing portion 101 recognizes what process has been selected/activated based on the time information, and based on the feedback information from deciding portion 121, updates status information of the corresponding object.

Further, in determining specific contents of processing of the element or procedure constituting the object, if it is necessary to resolve link information or external reference, that is, if the information to be resolved is contained within the object description to be processed, deciding portion 121 requests management processing portion 104 in object managing portion 101 for the necessary object or data.

In response to the request from deciding portion 121, management processing portion 104 obtains necessary information from storing portion 102 or communication portion 105 using searching portion 103, and passes the obtained information to deciding portion 121. Based on the information applied from searching portion 103 in the object managing portion, deciding portion 121 establishes the specific contents of processing. At this time, if the information necessary for establishing the specific contents of element or procedure related to the object cannot be obtained, object managing portion 101 determines that there is an error, and error processing starts.

Clock 124 connected to deciding portion 121 and operating portion 122 is typically a real time clock (RTC). However, it is not limited and any means that can provide time information may be used. This is in consideration of use in virtual time, and at this time, it is used for testing in advance an action of the information processing apparatus with respect to the defined time.

When the object passed to deciding portion 121 is a general object and not a time-constrained object or time-variable object, or when it is an object generated by generating portion 123 and does not require any decision based on time information, deciding portion 121 does not need any operation. This means that compatibility with a general object-oriented information processing apparatus is maintained, and that it allows mixed existence of a plurality of different types of objects.

Executing portion 130 is a unit for performing an actual information processing based on the contents of processing of the object determined by determining portion 120. Executing portion 130 includes an interpreting portion 131, an execution processing portion 132 and an information presenting portion 133.

Interpreting portion 131 decodes a code to be executed as an output from operating portion 122 in determining portion 120 to machine language, which is executed by execution processing portion 132.

Executing portion 130 performs, as needed, an output process including a display process, on output portion 140 through execution processing portion 132.

Information presenting portion 133 is a mechanism for presenting to the user information when there is a change in the specific contents of the element or procedure of the object. Information presenting portion 133 separately obtains information of process contents determination from deciding portion 121 and operating portion 122 in determining portion 120, determines whether information is to be presented or not, and performs a process related to the contents to be presented.

The information processed by information presenting portion 133 is to facilitate presentation of information to the user, such as presentation of contents of the process that is changed by determining portion 120. Such a process for presenting information is executed by execution processing portion 132 from information presenting portion 133 separately through interpreting portion 131, and the result is output to output portion 140. For this purpose, information presenting portion 133 successively holds therein the information of process contents determination from deciding portion 121 and operating portion 122, and compares with process determination information notified when the process is changed, so as to determine whether there is any information to be presented or not. The comparison is similarly made for each of the elements or processes in the object, and in addition, transition among some of the objects may be compared. Here, for such comparison, a configuration may have to be provided, in which information for determining relation between at least two objects, that is, which is preceding or succeeding, is held as needed.

The manner of output by information presenting portion 133 may be set in advance, or alternatively, it may be described as an addition to the process contents, information thereof may be transmitted from operating portion 122 to information presenting portion 133, information presenting portion 133 decodes the contents, and the actual manner of output may be determined.

The manner of output determined by information presenting portion 133 is not necessarily a text display including the contents of change. By way of example, a component arranged on a screen may be flickered or displayed in a different color, to indicate that the process has been changed with time. Other possible use of output portion 140 includes voice output, notifying the user of the change. In this example, the contents of processing that are actually changed are tightly coupled to the process by the information presenting portion. The relation may be sparse coupling. In that case, whether the context is consistent or not is confirmed by the user.

(Object to be Processed by the Information Processing Apparatus)

In the following, the object to be processed by information processing apparatus 100 will be described in detail.

Though the present invention will be described with reference to an operation of information processing apparatus 100 in the following, the present invention may be realized as a method performed by information processing apparatus 100, a program for causing a computer to execute such a method, or a medium recording such a program.

The object to be processed means a unit of information of which element or, procedure can be described at least based on information related to time.

The “element” is a variable or a property (attribute) in its general sense, including a dynamic or static variable, and involves an instance variable or instance itself in object-oriented programming.

The “procedure” refers to a course of action, defining an operation on data. In object-oriented programming it means a “method”. However, the object to be processed by information processing apparatus 100 is not necessarily limited to the method of the object encapsulated in a data-dependent form. This means that a procedure more open in terms of time can be realized, and processes related to time may be externally handled, and thus, the procedure is not necessarily limited to the concept of object or method in a general object-oriented programming.

It is noted here that the object having time concept as an object to be processed by information processing apparatus 100 is not exclusive of other object not having the time concept at the time of execution, as will be described in detail in the following.

Information related to time is uniquely set on the element or procedure of an object to be processed by information processing apparatus 100.

Such time information may be one of the following two types. The first is time constraint indicating a time period in which the process or variable is effective (time-constrained object). The second is time information in such a description format in which description of contents of an element or procedure of the object itself is defined to have the time information as one variable, and the time information is directly applied to a term of time, so as to determine actual processing (time-variable object).

As for the former, time-constrained object, effective time or period of an element or procedure is described for the element or the procedure, whereby a process is realized in which the effective time of the process is determined during execution. The latter, time-variable object) is provided with a time-dependent term in the description of an element or procedure, and the time-term is adapted during execution, so that specific contents of procedure are established.

In an aspect, by defining a domain of the time dependent term, a time constraint can be realized. Therefore, the description of time dependent process based on the time-term can comprehensively cover the concept of the former, time-constrained object directly. Naturally, the time constraint and the time-term can be described simultaneously in an object, as the methods of describing these are separable.

When a time-constrained object as an object to be processed by information processing apparatus 100 is generated from an arbitrary time-constrained object as a parent, the time-constrained object inherits an element or procedure contained in the parent object, including the time constraint imposed on the element or procedure. The generated child element can inherit the property of the parent object, as far as it is authorized. The authorization, however, is systematically determined based on an access control setting by an object programmer. Therefore, an unauthorized use of a copy of an arbitrary time-constrained object by a third party, or alteration of the time constraint from the original, can be prevented.

Generally, in the course of actual processing based on an element or procedure of a child element, information of the parent object is referred to, and access authorization to the process to be inherited is confirmed, so as to determine whether inheritance is possible or not. Here, a method requesting the parent object for delegation of authorization at a necessary level is attached to the time-constrained object, to confirm permission of execution. The unit of inheritance may be the object itself of individual element or procedure, and not any element or procedure that takes multiple modes over time in the individual item under a specific time constraint.

It is noted, however, that as for an override (in this case, including one for property) related to an element or procedure of the time-constrained object, it is possible to request the parent object for the delegation of authorization, and to override the time constraint after permission. At this time, consistency of time constraint on the element or procedure of the parent object is decided at the time of execution, and a process on the overridden element or procedure of the child object is selected with priority. An arbitrary time-constrained object may refer to or inherit only the time constraint added to an element or procedure of the time-constrained object as a reference source after the process of authority delegation, and using this, it is possible to describe a process dependent on a part of a process by the parent object.

In the process related to the inheritance/reference of the time-constrained object, processes related to the transfer of authority and the reference are performed between deciding portion 121 in determining portion 120 and management processing portion 104 in object managing portion 101. Among these, by way of example, such an object processing is possible in which a given time constraint is imposed on an object as a reference source, and an offset therefrom is designated, so that time-coordination with the object as the reference source is established.

Here, the time constraint of the object to be processed consists of the offset and link information to the time constraint of the object as the reference source, and the time-offset is described in a format based on relative time designation.

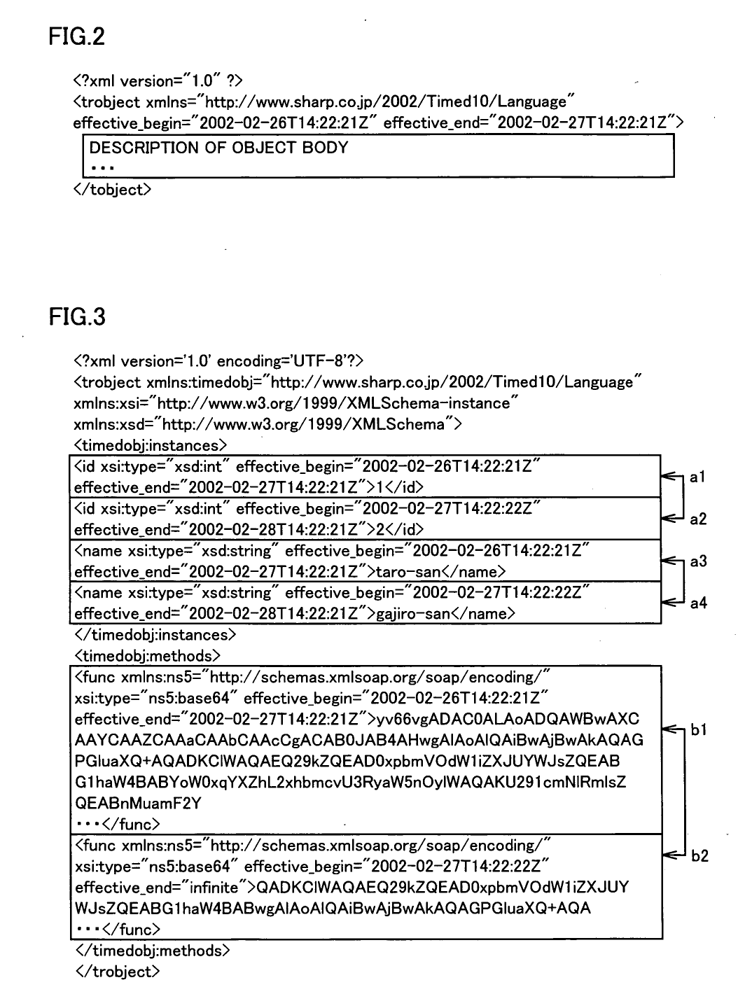

FIG. 2 shows an exemplary description of an object on which time constraint is imposed. In the description shown in FIG. 2, XML is used as an example for convenience of description. When the object is implemented in a specific format, description may be in a format dependent on the method of implementation.

The object description example shown in FIG. 2 relates to an object that includes a time constraint modifying the whole object, and the time constraint is realized by adding tags for setting the effective time in symmetry.

In FIG. 2, an element trobject has time-description attribute, in which effective_begin attribute designates a time when the object becomes effective, and effective_end attribute designates a time when the object becomes ineffective.

The format of time designation in FIG. 2 is in accordance with the description in a syntax of IS08601. It is sufficient, however, for the executing system to support the limited description grammar. It should be noted that the time-description attributes described above do not indicate the time point at which the action related to the object is actually started or terminated.

As for the framework for describing time constraint on an object, it is well possible to describe the time constraint using the same element, attribute name and value as constructors described in Timing and Synchronization Module in compliance with SMIL2.0 specification. Such a description is useful to attain higher convenience for use.

It is noted, however, that semantics is used in a format dependent on a specific name space. Further, there is an effect that by adding an improbable time constraint, a designated process can be temporarily made ineffective.

FIG. 3 shows an exemplary object description in which separate time constraints are imposed on each of the elements or procedures of the object.

It is possible to add different time constraints to each element and each procedure of the object to be processed by information processing apparatus 100. This provides time-related versatility to every element or procedure.

By way of example, an id element and name element in FIG. 3 are based on different time constraints as denoted by marks a1 and a2 and marks a3 and a4, and therefore, these can be described mixedly in one same object. At determining portion 120, an appropriate property is selected at the time of execution.

Similarly, in a methods element defining a process, different time constraints are imposed as denoted by marks b1 and b2, and therefore, these can be described mixedly and at determining portion 120, an appropriate property is selected at the time of execution.

In the description of FIG. 3, an example is shown in which elements constituting the object are contained in a single object, including processing code in binary notation. Even when all the related elements are included in a single object, it is desirable that a name space designation is added in a regular manner.

Each of the elements or procedures in the object is appropriately selected by deciding portion 121 at the time of executing object processing, and an execution code related to the selected process is transmitted to executing portion 130. When there are a plurality of elements having time constraints imposed on the same element or procedure and there are overlapping time constraints among these, deciding portion 121 detects and notifies management processing portion 104 about that, to activate a necessary error processing.

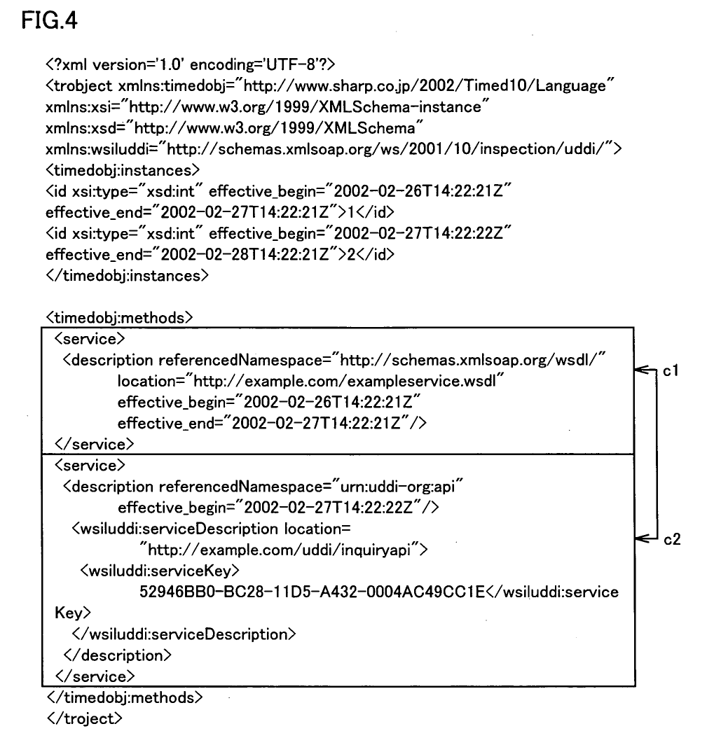

FIG. 4 shows an exemplary description of an object, which includes a plurality of descriptions based on time constraints and at the same time, the object includes an external reference.

Contents of procedures described with mark c1 or c2 have mutually exclusive time constraints added thereto, so that these descriptions can exist together in one same object, and the contents of processing explicitly present a reference to a service on the network.

The time constraint imposed in this example is a constrained condition for determining a process on the object processing side, and actually, it is different from the time constraint imposed on the service separately provided on the network.

When there is a need of an access based on an external reference, a notice is given from determining portion 120 to object managing portion 101, and communication portion 105 searches and retrieves data.

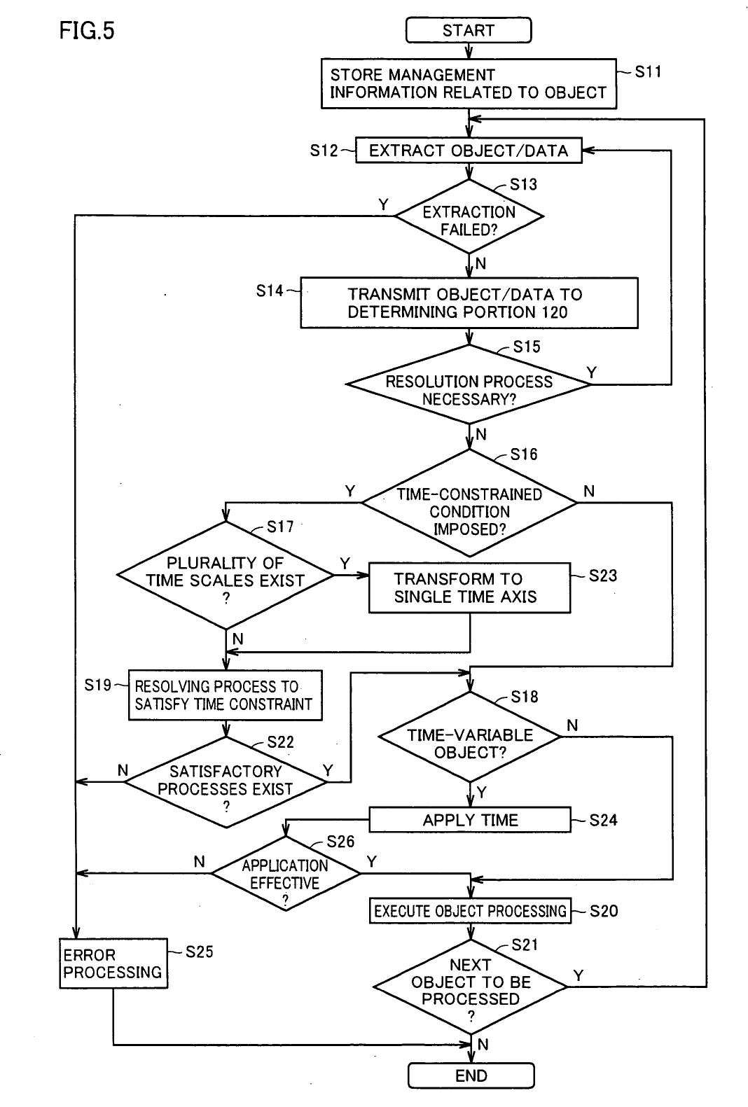

FIG. 5 is a flow chart representing an object processing algorithm related to a process executed by information processing apparatus 100 in accordance with the present invention.

When a program is read first to a main memory of storing portion 102, management processing portion 104 stores management information related to the object as the components of the program in storing portion 102 (step S11).

In step S12, management processing portion 104 searches and extracts objects to be successively processed when the program is executed or data required for execution, in response to a request from data management processing portion 104 itself or from deciding portion 121, using searching portion 103, storing portion 102 and communication portion 105. Details of the algorithm in step S12 will be described later.

In step S13, whether retrieval of the necessary information of the objects or data has been failed in step S12 or not is determined. If retrieval of the information has failed, an error processing starts in step S25, and thereafter, the program is terminated.

The process in step S25 includes exception handling.

If the objects or necessary data have been obtained in step S12, they are transmitted from object managing portion 101 to determining portion 120 in step S14, and a specific processing is determined.

In step S15, as long as other information is necessary to determine behavior of the object, determining portion 121 makes a transition of the process back to step S12, to extract necessary information ([resolution processing]). This situation occurs when an object is configured to have a plurality of external references, or when an object inherits or refers to a time constraint of another time-constrained object. When a plurality of pieces of information are necessary, operation repeatedly proceeds in the loop from step S12 to step S15, until all are resolved.

Though the foregoing represents a process for obtaining information related to a single object, processes related to a plurality of objects may be performed in parallel.

When all the information necessary for establishing the process described in the object is resolved, the flow makes a transition to step S16, and whether the process related to the element or procedure of the object to be processed is related to a time-constrained object or not is determined. In case of a time-constrained object, that is, when time-constrained conditions are imposed on respective elements or procedures of the object of interest, on every condition, determination based on matching with time information is performed after step S17.

When the object to be determined in step S16 is not a time-constrained object, whether the process related to the element or procedure of the object to be processed next is of a time-variable object or not is determined in step S18. If the object of processing is not a time-variable object, the flow directly makes a transition to step S20, so that a general object processing is performed by the executing means.

This means that the processing in information processing apparatus 100 allows co-existence of common objects of the object-oriented model that are not dependent on time information, as such an object is determined to be one without any time constraint.

In step S16, when the object of processing is a time-constrained object, the flow makes a transition to step S17, and whether a plurality of time scales exist or not is determined, in relation to the element or procedure of the object to be processed.

When there are a plurality of scale descriptions given on one item, the flow makes a transition to step S23, to effect conversion to a single time axis. A plurality of time scales may exist mixed in one object or on one item if given options are all sparse in time. Further, it is possible to apply, mixedly on one item, not only the time scale but different methods of designation such as absolute time designation and interval designation, or relative time designation. The process for resolving this takes place in step S19. Detailed algorithm in step S19 will be described later.

After scale conversion in step S23, or when time scale resolution is determined to be unnecessary in step S17, the flow makes a transition to step S19, in which the description related to the element or procedure in the time-constrained object is matched with time information, to select a process that satisfies the time constraint.

When there is no process that satisfies the constraint in a candidate set, the flow makes a transition from step S22 to S25, in which error processing or exception handling is done, and then, the process ends. Here, in the error processing in step S25, only an error notice may be transmitted separately to object managing portion 110, and thereafter, a process defined by an object transmitted from object managing portion 110 thereafter may be performed. This approach is effective when, though the time constraint cannot be satisfied at the time of execution of the process, there is still a possible option that can be executed on condition. By way of example, this approach enables such a process that, when there is an option that can satisfy the constraint after a few seconds, information thereof is presented while the processing is suspended.

In step S22, when there is a process that satisfies the constraint in the candidate set and the selection process is done, the flow makes a transition to step S18. In step S18, whether an element or procedure that should be resolved as a time-variable object is contained in the object of interest or not is determined, and if contained, the flow makes a transition to step S24 in which the time substitutes for the time term.

If such an element or procedure is not contained, in step S20, a process related to a time-constrained object for which a process satisfying the time constraint has already been selected, or a process described in an object not at all related to time information, is executed.

In step S24, the element or procedure of the object to be resolved are defined as a function including a time term t, with the time information being a variable of the contents of description itself. Examples of procedure related thereto include an encrypting function in which a time at which it is instantiated serves as an encryption key or an element determining the function, a method having a non-linear characteristic of which phases differ time to time, or a method by which color of display changes with time. Examples of element may include one that describes a process of which behavior changes dependent on the applied time, in an algebraic manner, such as an instance variable of which initial value changes dependent on time.

The format of description defining the element or procedure of the object may not necessarily be a continuous function, and it may be freely described/designed by a system designer. By way of example, the format of description of the method defining an object procedure may be a step function with respect to t, at a prescribed interval. It is desirable that the domain on which the time variable t with respect to the function output is well-defined, and in that case, it is possible to verify applicability at time t. This means that a function covering the verification of time constraint of the time-constrained object described above can be realized by the method of verifying time-variable object. In short, by making a reference to the output value after the object has been processed as a time-variable object, it is possible to evaluate relevance of use of that process (in the simplest manner, a binary evaluation function may be employed, in which time information is applied and when the returned functional output is 0, the process is unacceptable, and when it is 1, it is acceptable). In this case, a rule set for re-evaluating a function output after the time is applied by operating portion 122 is prepared by management processing portion 104, the functional output is once fed back from operating portion 122 to deciding portion 121, and relevance thereof is evaluated. In the format of describing a time variable object, a reference may be made to a service provided on a network, together with usability thereof, in a time-dependent manner. Specific implementation will be described later.

In step S24, time information is applied to a time-dependent variable included in a description related to an element or procedure constituting the object, whereby actual contents of element or procedure are established by operating portion 122. Basic time information applied to the time-dependent variable is a current-time-information from RTC. It is noted, however, that for verifying operation of a time-variable object, for example, virtual time information may be used as an input as an effective method. In that case, a clock connected to determining portion 120 may be operated from the outside, so that information output therefrom can be controlled. Alternatively, such a method may be readily realized by inputting clock information separately from the outside to determining portion 120.

In step S26, after the time information is applied to each item of the time-variable object in step S24, relevance thereof is verified. In short, this is to find a situation where the domain of time term t is ineffective with respect to the applied time. When the applied time cannot satisfy the domain of time term t of the function, the process makes a transition to step S25, in which error processing is executed.

When the term t is within the domain, the applied result is used as it is to execute the process described in the object, in step S20.

Thereafter, in step S21, in the course of executing the program, if the object to be processed next exists under control of management processing portion 104, the flow makes a transition to step S12, so that the process related to that object is to be done with determining portion 120.

When all the processes defined are executed, execution of the program ends.

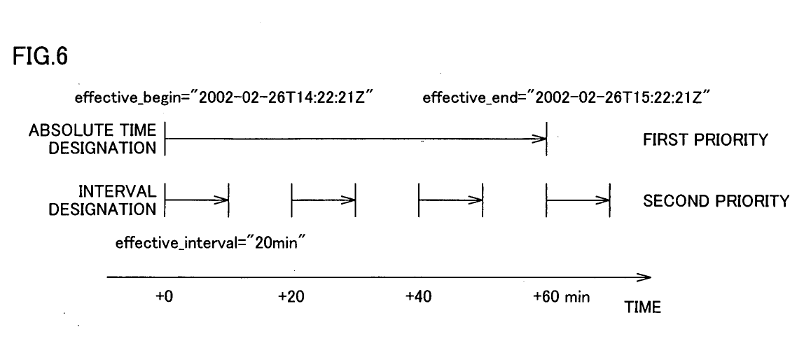

FIG. 6 is a schematic illustration showing an example in which different methods of designation such as absolute time designation and interval designation are used together in one same item in the internal description of a time-constrained object. In FIG. 6, it is assumed that time constraints to be imposed on a specific element described in the time-constrained object are described in two different methods of designation.

A long arrow at an upper portion denotes a time constraint defined based on absolute time designation, and intermittent four arrows therebelow denote time constraint based on interval time designation, which are intended for the same property.

When different methods of time designation are used, there may possibly be a period on which time constraints overlap. This applies to the example of FIG. 6. Here, deciding portion 121 confirms priority of description methods through management processing portion 104, so as to resolve description-related conflict. The process defined by the interval designating method is recursive, and therefore, by way of example, it has lower priority than the absolute time designation, considering importance of processing defined thereby. When such information is obtained and decided by deciding portion 121, effective property can be selected. The rule as to the manner of granting priority depends on the processing system, and if existence together is allowed, order of priority among these must be established in advance.

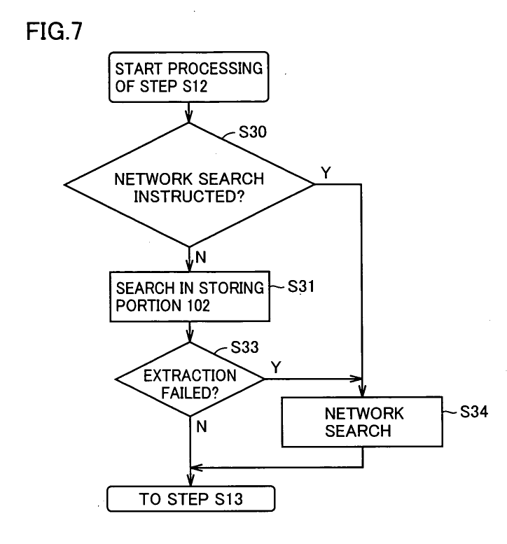

FIG. 7 is a flow chart representing a detailed algorithm of step S12 shown in FIG. 5.

After the step S12 starts in FIG. 5, whether retrieval of an object or data on the network is explicitly designated or not is determined in step S30.

When retrieval of information on the network is designated, the flow makes a transition to step S34, in which the object or data on the network is searched for, by communicating portion 105.

When retrieval of information on the network is not designated, the flow first makes a transition to step S31, in which an object or data stored in storing portion 102 is searched for. If the desired object or data cannot be extracted as a result, determination thereof is made in step S33, and then the flow makes a transition to step S34, in which the object or data is searched on the external network.

When the desired data can be found in storing portion 102, the process of step S12 is terminated, and the flow makes a transition to step S13 shown in FIG. 5.

By performing operation along the flow of FIG. 7, it becomes possible to link a plurality of resources such as objects with external reference through a network, and to obtain time-constrained data related thereto from storing portion 102 as a local storage area or through the network, or to describe a service on the network in an object.

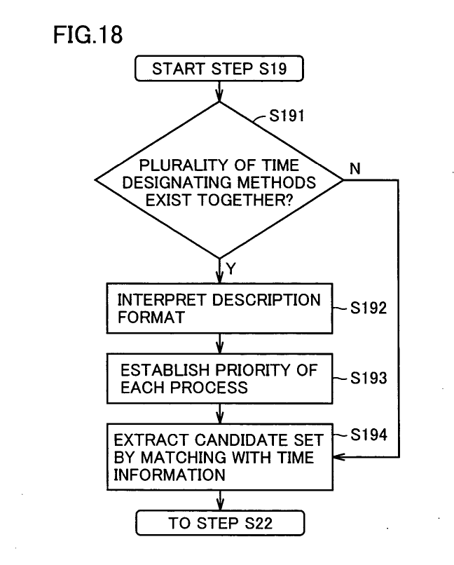

FIG. 18 is a flow chart representing a detailed algorithm of step S19 shown in FIG. 5. In step S191, whether there are a plurality of time designating methods or not is checked. When there are a plurality of time designating methods, each description format is interpreted in step S192, and priority of each format is established in step S193. Otherwise, the flow makes a transition to step S194, in which a set of process candidates that satisfies the time constraint is extracted. An example of the priority establishing process of step S193 is that, when interval designation and absolute time designation exist together, priority is adjusted such that the absolute time designation is selected with high priority, as the process defined by interval designation is repetitive and repeated periodically at every prescribed time interval. The rule set related to priority adjustment may be a given one, or it may be introduced from the outside, with its policy managed by management processing portion 104, and the applied rule set is used in determining the process by deciding portion 121. Generally, a process defined by an object is highly dependent on context, and therefore, flexible handling is required. As an example other than those described above, in a process for providing a Qos service, the process designated by an interval must be given higher priority than a process designated by an absolute time particularly with respect to service guarantee per unit time, and therefore, a scheme that realizes selection of an appropriate rule for various contexts is realized.

In step S194, the information with the priority added and the applied time information are referred to, so that a set of process candidates of the elements or procedures of the object that satisfy the time constraint is extracted.

Information processing apparatus 100 having such a configuration as shown in FIG. 1 processes along the flow chart of FIG. 5, whereby an adaptive information processing is realized, in which the property of an object containing time information in its element or procedure contents is changed with time.

Further, it is possible to set different time constraints with various time scales and various methods of designation for each of the elements or procedure contents of the object to be processed, and thus, information processing apparatus 100 that allows description of flexible processing such as changing the meaning of a procedure itself dependent on time, can be realized. This means that one button may have different meanings at different times, for example, and hence, it may be effective for a terminal and home-use appliances that have limited resources.

Further, it is possible to encompass processes under such different time constraints in a single object, and therefore, processing based on time information becomes possible even in home-use appliances that do not have any communication function.

In addition, it is possible to have an object refer to or inherit a behavior including time-constrained information of another object. Consequently, a dependent model, in which a behavior of an object depends on a time constraint of another object, or a coordinated model between objects can be built systematically.

Further, information processing apparatus 100 having, as an input source, not only the real time information but virtual time information can be realized, effectively making it more convenient for contents/service providers.

Even network services can be coordinated under time-constrained condition, and therefore, high affinity to decentralized processing can be attained. In addition, an object can be re-configured based on element or procedure contents selected to satisfy the time constraint, and processing can be done using the thus provided object, whereby process overhead can be eliminated, and hence, it is expected that performance in executing a specific process can be improved. Further, a processing system can be realized in which objects having their property dependent on time information, and objects of normal object-oriented system without time-dependence exist together.

[Second Embodiment]

An information processing apparatus 200 in accordance with the second embodiment will be described with reference to the figures.

In the following, the present invention will be described based on an operation of information processing apparatus 200. It is noted, however, that the present invention may be implemented as a method carried out by information processing apparatus 200, or as a program causing a computer to execute such a method, or as a medium on which such a program is recorded.

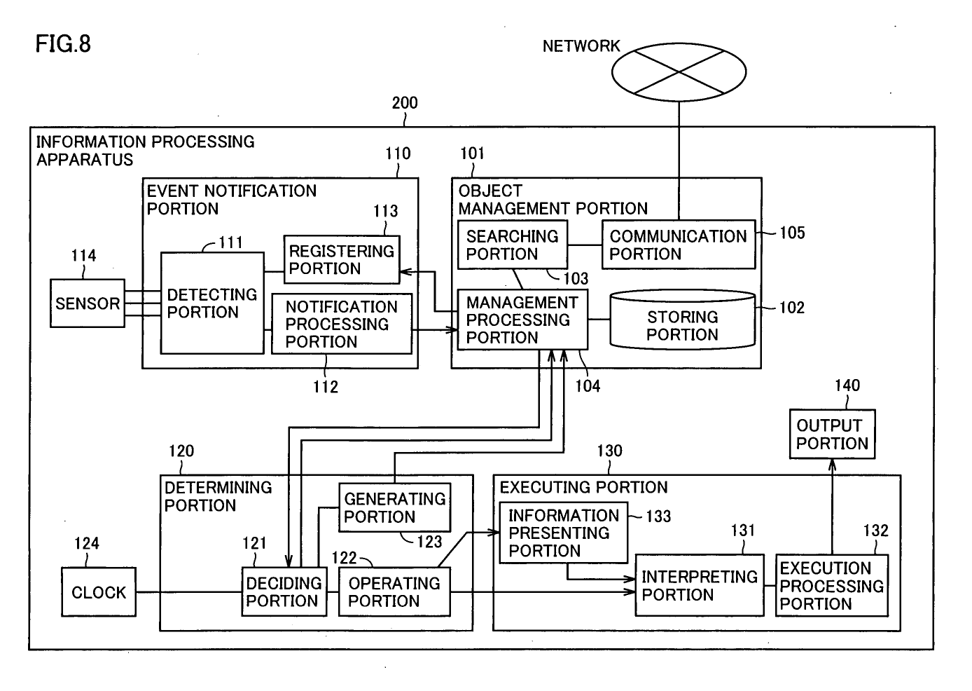

FIG. 8 is a schematic block diagram representing a configuration of information processing apparatus 200 in accordance with the second embodiment of the present invention.

Information processing apparatus 200 of FIG. 8 includes, in addition to the configuration of information processing apparatus 100 of the first embodiment, an event notification portion 110.

Other basic configuration of information processing apparatus 200 is the same as that of information processing apparatus 100 of the first embodiment, and therefore, same portions are denoted by the same reference characters and description thereof will not be repeated.

Referring to FIG. 8, event notification portion 110 is a unit that registers/holds event conditions based on external information of a sensor or the like, and notifies object management portion 101 about an event that occurs when a condition is satisfied, and this portion includes a detecting portion 111, a notification processing portion 112 and a registering portion 113.

Detecting portion 111 is connected between a group of a plurality of external sensors 114 and a clock 124, detects occurrence of an external event based on an event firing condition registered in registering portion 113, and when an event satisfying a registered condition occurs, notifies the notification processing portion 112 about the information.

As clock 124 is used in addition to a group of sensors 114, it becomes possible to define an event condition by a combination of time and event. By way of example, an event may be fired dependent on status information indicated by an infrared sensor at a certain reference time point, a different event is fired when an additional condition is imposed that a button component is pressed/not pressed by a user at a certain time point, or an event is fired only when a status of a button component is kept unchanged for 5 seconds after it is pressed, and in this manner, an event can be generally defined based on a combination of a plurality of conditions.

The sensors may be connected/disconnected one by one, and on this premise, setting of event condition reflects sensor connection information.

Notification processing portion 112 notifies management processing portion 104 in object management portion 101 about the information related to the fired event. Consequently, object management portion 101 activates, in an event-driven manner, an object related process prepared beforehand in an event-driven manner.

Registering portion 113 provides a mechanism for registering/holding a setting related to the condition for giving an event notification, and setting is done by management processing portion 104 in object management portion 101. This is because it is natural to register information of an object to be activated in a body that manages the object, when the manner of use is such that a specific object is activated in an event-driven manner.

It is noted, however, that the user may perform an operation to explicitly associate an event condition and an object to be activated. For this purpose, an interface mechanism (not shown) receiving an external input may be provided between event notification portion 110 and object management portion 101, so as to allow the user to register an event and to designate association with an object to be activated, and exchange of information between the interface mechanism and event notification portion 110 or object management portion 101 may be selectively made possible.

In management processing portion 104, an object prepared in advance in correspondence to the fired event is transmitted to deciding portion 121, whereby it is activated in the event-driven manner. It is noted that management processing portion 104 transmits not only the object as the direct object of processing but also information related to an object activated in relation to the event firing, to deciding portion 121. This information is transmitted through operating portion 122 to information presenting portion 133 in executing portion 130, to be used for information processing to notify the user about the change, as information of change in specific contents of the element or procedure of the object associated with the event firing.

Information presenting portion 133 compares the information with information related to a process of the object in the past stored therein, determines whether there is information to be presented or not and determines a specific processing, and actual information presenting process is performed using interpreting portion 131 and execution processing portion 132.

Management processing portion 104 has a function of adjusting event firing condition and registering with registering portion 113 at a timing earlier than the actual event firing timing, and performing delay control from notification of the event firing timing from notification processing portion 112 to management processing portion 104 until the object is actually activated. This is closely related to transmission of the information of change in specific contents of the element or procedure of the object to be activated that is notified to information presenting portion 133, and in order to enable execution of the process by information presenting portion 133 earlier, management processing portion 104 performs earlier registration of event timing and delay control of event firing time.

Consequently, it becomes possible to present the change in specific contents of the element or procedure of the object at a timing earlier than the actual object processing. By way of example, when a shape of an object arranged on a screen is to be actually changed, it may be flickered a prescribed time before the actual change to attract attention of the user; notification such as “operation contents will be changed in . . . seconds” may be given as a display image output or voice output; and when an UI component is realized as a time-constrained object, a UI element of which display or operation contents change with time can be realized and at the timing of change, an animation process may be inserted to notify the user about the change.

Deciding portion 121 of determining portion 120 determines the element or procedure of the object to be processed transmitted by management processing portion 104 after event firing, and thereafter, refers to the time-constrained condition added to the determined process, whereby the timing of determination of the next object processing can be expected. Deciding portion 121 may register this as an event occurrence timing in registering portion 113 using management processing portion 104, so that timings for determining processes of the next and the following objects can be scheduled in advance.

This has an effect that a time-event-driven type information processing becomes possible, in which at a time point when a time-constrained object expires, the next object processing is selected and executed. By way of example, such a process is possible that meaning of a display or an operation of a UI component displayed on a screen is changed at a certain time point in a sort of automatic manner without any explicit instruction or action by the user.

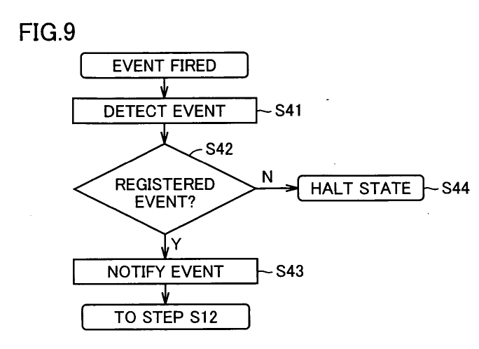

FIG. 9 is a flow chart representing an event-driven algorithm performed by information processing apparatus 200 having such a configuration as shown in FIG. 8.

The algorithm is formed as an addition to the algorithm of the first embodiment shown in FIG. 5.

Specifically, when an event that has been registered in registering portion 113 in event notification portion 110 is fired, in step S41, the event is detected by detecting portion 111 in event notification portion 110. Then, the flow makes a transition to step S42, in which whether the detected event is the one that has been registered in registering portion 113 or not is determined. If it is identified as the registered event, the flow makes a transition to step S43, and otherwise, the flow makes a transition to a halt state (step S44).

In step S43, notification of the information of the fired event is given to management processing portion 104 in object management portion 101, and at the same time, management processing portion 104 transmits information of the object that is activated in association with the event firing to deciding portion 121. This information is used in information presenting portion 133 in executing portion 130. Then, the flow makes a transition to step S13 of FIG. 5.

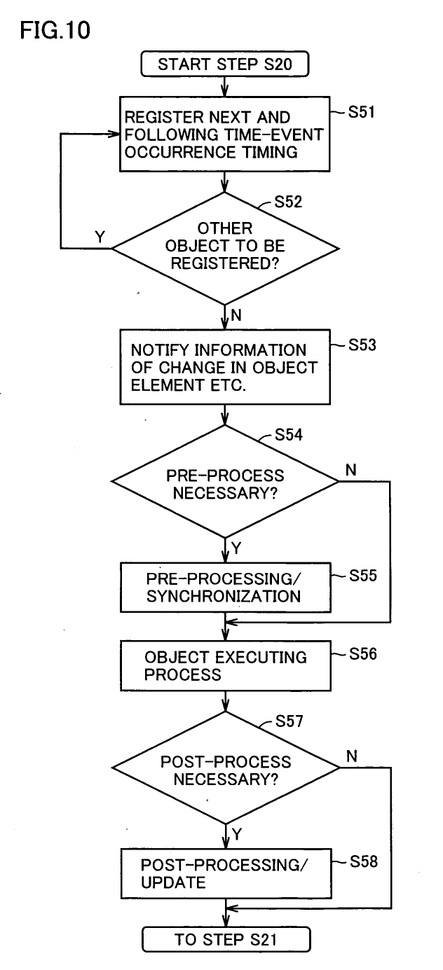

FIG. 10 is a flow chart representing an event-driven algorithm followed by information processing apparatus 200 having such configuration as shown in FIG. 8.

The algorithm shown in FIG. 10 is executed in place of step S20 of the algorithm of the first embodiment shown in FIG. 5, and is related to the process executed by determining portion 120 and executing portion 130. Therefore, in the following, description will be given also referring to FIG. 5.

After the start of the process of step S20 in the flow chart of FIG. 5, in step S51, a time event occurrence timing related to the next or later object processing by deciding portion 121 is registered as an event in registering portion 113. Thus, an event-driven operation is confirmed and set.

As to event registration that takes place in step S51, a plurality of time events may be registered for every object element or procedure of a plurality of objects, and as long as there remains an event to be registered in step S52, the flow returns to step S51 to repeat event registration. It is noted, however, that such repetitive registration is allowed within upper limit of numbers of events that can be registered, as well as hardware and other limitations.

In step S53, management processing portion 104 notifies information presenting portion 133 in executing portion 130 through deciding portion 121 and operating portion 122 about the information related to the object that is activated in association with the event firing. The notification includes information of change in specific contents of the element or procedure of the object associated with the event firing.

In step S54, whether a pre-processing is necessary or not before the actual processing to the object or not is determined, and if the pre-processing is necessary, it is done in step S55. The process includes pre-processes such as presenting the change by information presenting portion 133 or delay control/synchronization until actual activation of the object by management processing portion 104.

After pre-processing, or when such a pre-processing is unnecessary, the main process defined by the object is executed in step S56.

Thereafter, in step S57, whether a post-processing is necessary or not is determined, and if the post-processing is necessary, it is done is step S58. This process includes an update of information related to determination of process contents related to element or procedure of the object to be stored in information presenting portion 133.

After this process, the flow makes a transition to step S21 of FIG. 5.

Information processing apparatus 200 having such a configuration as shown in FIG. 8 processes along the flow charts of FIGS. 5, 9 and 10, whereby an information processing is realized, in which the property of an object containing time information in its element or procedure contents is changed with time, and such process is done in an event-driven manner.

Further, when sensing information related to the aspect of use such as the user, application or terminal is incorporated as an input source, information processing based on more detailed services becomes possible.

Further, a presentation type information processing is possible, in which the change in specific contents of the element or procedure related to the object processing is notified to the user at the timing of change.

Further, as the event occurrence timing is given in advance, it becomes possible to present notification related to the change in specific contents of the element or procedure of the object at a timing earlier than the actual object processing. By way of example, when a shape of an object arranged on a screen is to be actually changed, it may be flickered a prescribed time before the actual change to attract attention of the user, or notification such as “operation contents will be changed in . . . seconds” may be given as a display image output or voice output.

Further, when a UI component is realized as a time-constrained object, a UI element of which display or operation contents change with time can be realized and at the timing of change, an animation process may be inserted to effectively notify the user about the change.

In addition, such a manner of use is possible that the timings of determining object processing are scheduled beforehand, and therefore, a time-event-driven type UI component can be realized in which meaning of a display or an operation of the UI component is changed at a certain time point in a sort of automatic manner without any explicit instruction or action by the user.

[Third Embodiment]

An information processing apparatus 300 in accordance with a third embodiment will be described with reference to the figures.

Information processing apparatus 300 realizes a user interface (UI) such as described below.

As a supplemental description of the UI realized by information processing apparatus 300, characteristics of the UI will be described. An UI is closely related to an object application, and generally, the display or operation contents are much dependent on the application. Therefore, for the processing thereof, generally an approach is taken in which a system developer prepares a program to realize a desired process one by one.

This is on the premise that all the interaction patterns between the system and the user are under control of the system administrator. In an environment attained by developed networks in which ubiquitous network services are searched for and utilized, it is out of question that a system designer exhaustively covers all the appropriate UI patterns.

Therefore, it is necessary to improve user-friendliness in using ever-increasing network services by providing a framework that enables sorting out appropriate interactions. Selection of an optimal interaction between the user and the system using time as a key may be a resolution to the problem of providing appropriate information presentation/operation among connections with high granularity.

(Configuration of Information Processing Apparatus 300)

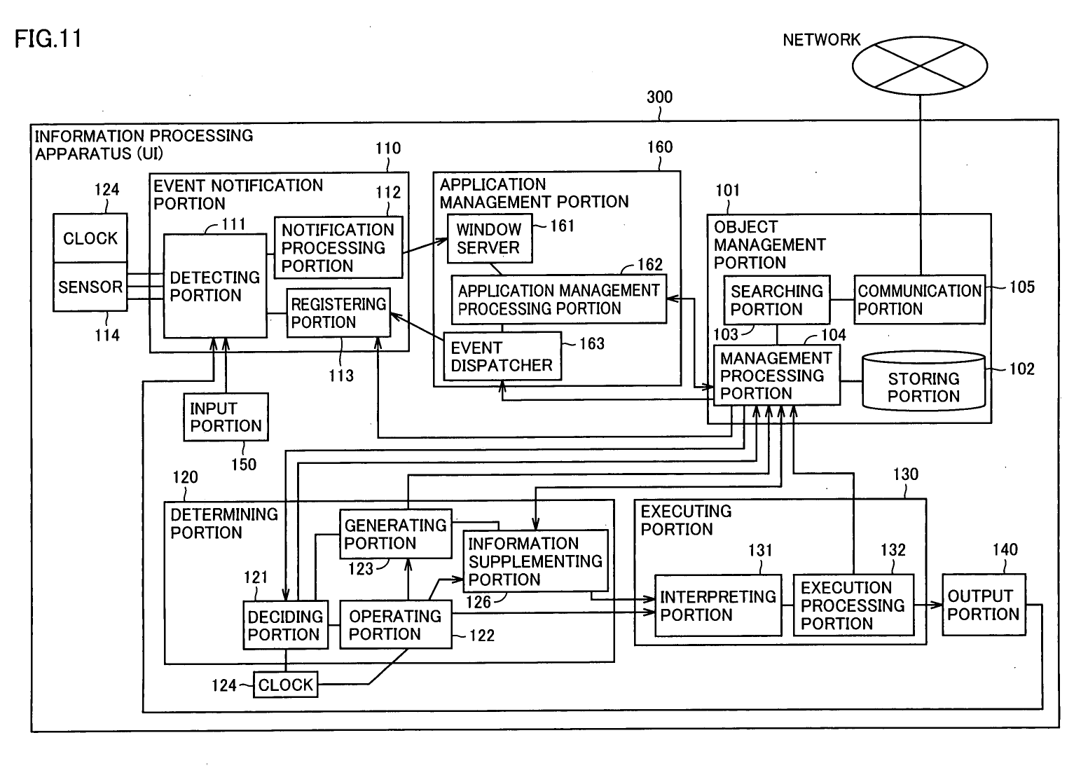

FIG. 11 is a functional block diagram related to the UI realized by information processing apparatus 300 in accordance with the present invention.

In the following description also, the present invention will be described based on an operation of information processing apparatus 300. It is noted, however, that the present invention may be implemented as a method carried out by information processing apparatus 300, or as a program causing a computer to execute such a method, or as a medium on which such a program is recorded.

Information processing apparatus 300 of FIG. 11 is based on information processing apparatus 200 in accordance with the second embodiment shown in FIG. 8, and configured to realize services of higher level.

The basic configuration of information processing apparatus 300 is the same as that of information processing apparatus 200 in accordance with the second embodiment, and therefore, the same portions are denoted by the same reference characters and description thereof will not be repeated.

Therefore, in the following, only the portions different from and supplementary to information processing apparatus 200 of FIG. 8 will be described.

Referring to FIG. 11, an input unit 150 is a unit for obtaining a user operation on a UI displayed on a screen, represented by a device such as a mouse, a keyboard or a pressure-sensitive pad. Input portion 150 transmits contents of the user operation to notification portion 111 in an event notification portion 110.

Event notification portion 110 is a unit for notifying an application management portion 160 about occurrence of an output event from clock 124, external sensor 114, input portion 150 or output portion 140. Event notification portion 110 includes detecting portion 111, notification processing portion 112 and registering portion 113.

Detecting portion 111 is connected to clock 124, a plurality of external sensors 114, input portion 150 and output portion 140, and detects occurrence of an external event based on an event firing condition registered in registering portion 113. When an event satisfying a registered condition occurs, detecting portion notifies the notification processing portion 112 about the information.

Notification processing portion 112 transmits the information related to the fired event to application management portion 160. An event condition may be defined by a combination with time at the time of sensing, and in addition, by a combination with an input event or an output event. When a UI is to be formed, almost all conditions are set by the input/output event itself or by a combination of an input/output event and time.

An input operation by the user through a keyboard or a mouse is transmitted as an event from input portion 150 through notification portion 120 to application management portion 160, or, more accurately, to a window server 161 therein. Thereafter, the event is further transmitted from window server 161 to an appropriate application.

When an event occurs through input portion 150, information recording what is done by the user, for example, information of cursor position at that time point or which window was influenced, and other related information are transmitted.

By way of example, a “key-down” event occurs when a user presses a key on the keyboard, and a “key-up” event occurs when the key is released. Further, “mouse-down” event, “mouse-dragged” event and “mouse-up” event occur when the user presses the mouse button, drags the mouse button and releases the mouse button, and each event records one user action.

By way of example, for a key-down event, information of the pressed key and for a mouse-up event, information of the released mouse button are notified, together with position coordinates at the time when the corresponding action took place.

An event that occurs by the combination of an input/output event and time is fired at a timing when a counter value attains the same as the set value (including when a down counter attains to the value 0), with the clock counter activated at the time of occurrence of the corresponding input/output event. This means that a primitive event having the input/output operation combined with time can be described in event notification portion 110. The time-related condition, however, can be processed after event notification, and therefore, it is not always necessary to have the form of a primitive event condition.

The sensors may be connected/disconnected one by one in detecting portion 111.

Notification processing portion 112 notifies window server 161 in application management portion 160 about the fired event information.

Main functions of window server 161 are to provide an application with a window resource allowing drawing, and to perform processes for transmitting the event to an appropriate application. Each application communicates window server 161, whereby a window resource allowing drawing in a screen area managed by the window server is secured. Window server 161 is responsible for the control of monitoring events occurring in information processing apparatus 300, and passing events to the application.

When an event occurs, window server 161 obtains application information under management, using an application management processing portion 162, to specify a focused window in the screen area, that is, an application, and to specify an object as a body to which a message is to be transmitted. After the object is specified, window server 161 performs a messaging process using an event dispatcher 163 to the object as the object of the event, through an access by management processing portion 104 in object management portion 101.

Event dispatcher 163 manages, by an internal table, what event information is to be notified application by application, together with priority of each notification. When an event occurs, event dispatcher 163 refers to the internal table, and determines a messaging process for the object of interest.

Event dispatcher 163 stores event information to be given as notification to the application, and performs event management of a higher level. Specifically, in accordance with the context of application, primitive event services by event notification portion 110 notifying events of a lower level are combined, to be managed as an event suitable for the application. By way of example, assume that a mouse-dragged event from input portion 150 is passed to event dispatcher 163, and in some application, it is necessary to display a character sequence representing the meaning of operation on the screen after the mouse is kept at the dragged state for three seconds. In this case, the event dispatcher registers in registering portion 113 a timer event that is activated after three seconds, at a time point when the notification of the mouse-dragged event is received. In actual implementation, the process may be realized by a method in which status is checked after expiration of the three-second timer to confirm that the mouse is in the dragged state.

The application receives an event, processes in accordance therewith, and waits for another event. As long as events occur, the application continuously receives the events, and processes are performed in accordance with user actions transmitted in the format of events. Components of the objects forming the application will be described later.

By the messaging from application management portion 160, object management portion 101 activates, in an event-driven manner, a process related to the object forming the application. Setting and registration of event conditions in registering portion 113 in event notification portion 110 may be performed by management processing portion 104 in object management portion 101, in addition to window server 161 in application management portion 160. This is realized by a system that has unified manner to activate specific objects in an event-driven manner.

(Information Supplementing Portion 126)

Next, an information supplementing portion 126 in determining portion 120 will be described.

Information supplementing portion 126 is provided as a mechanism to replace information presenting portion 133, in an event-driven type configuration.

Information supplementing portion 126 is a mechanism that monitors, as needed, change in behavior related to an element or procedure of the object, and it is provided in determining portion 120 to consolidate the object processing function of information presenting portion 133 and to realize pre-processing.

Information supplementing portion 126 refers to the process contents determination information from deciding portion 121 and operating portion 122 and to object information managed by management processing portion 104, and traces any change therein. When there is a change in object processing and a process that is to be activated in responses to the change is defined by the object as the source of processing, the contents of the change are transmitted to management processing portion 104, and a process based thereon is activated.

When a different object is defined to be activated in response to the change in the object as the object of processing, information supplementing portion 126 refers to information from management processing portion 104 to confirm relevance between the objects, and when there is an object that is to be activated in response to the change, applies an object identifier identifying the object to be activated to management processing portion 104, to perform the process defined by the object.

Consequently, for example, contents of an object that change at a defined time may be displayed on a different window, or information related to the change in behavior of the object is presented to the user.

The process realized by information supplementing portion 126 is done as a process different from the main processing procedure, and therefore, when there exist a plurality of executing means, processes thereof can be done in parallel. When single executing means is used, the object processing activated by the information supplementing portion is set to be executed in a subroutine call or hook from the main process flow, and after the end of processing, the flow returns to the main process.

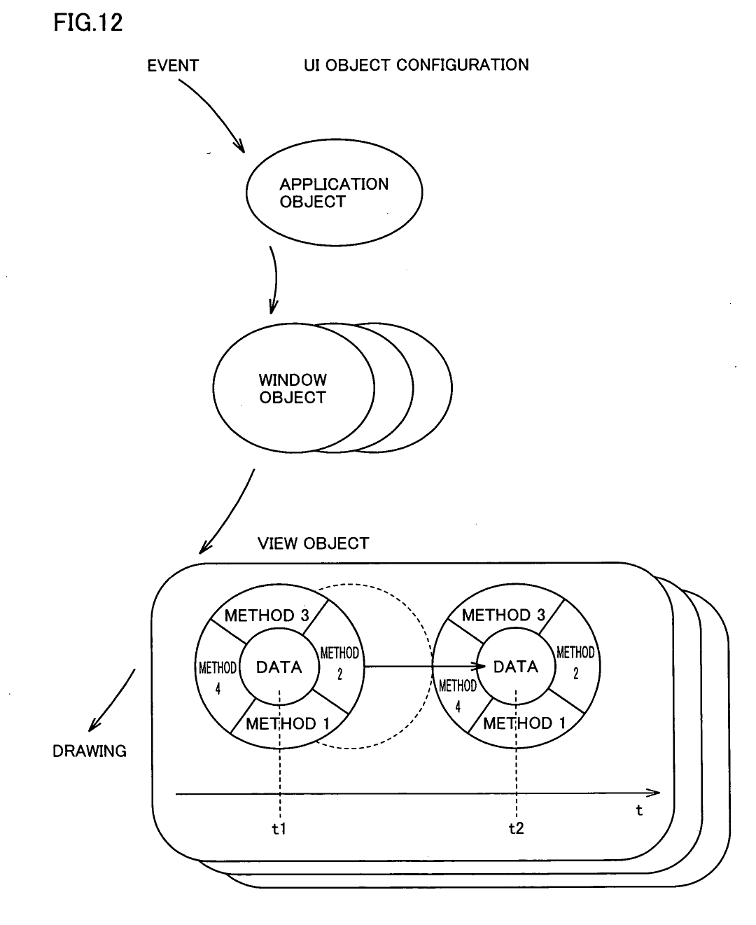

FIG. 12 shows application components in accordance with the third embodiment. An application has a hierarchical object configuration, which realizes the UI.

Each application has a single application object, a plurality of window objects, and a plurality of view objects dependent on each window object. That an application has a plurality of window objects corresponds to a case where the application requires a plurality of window and panels. An example is a simultaneous display of a setting panel and a drawing window. It is needless to say that there may be only one window object that depends on the application object.

Below each window, there are a plurality of view objects, which correspond to respective objects dependent on the window, and in the example shown in FIG. 12, these correspond to UI components.

Every object can describe a process that is based on time information, and an element or procedure may be changed dependent on time. Specifically, it is possible to change with time the behavior of objects belonging to any layer of a hierarchical configuration, in one same scheme. The UI is realized by such a hierarchical object configuration.

(Method of Notifying and Passing Events)

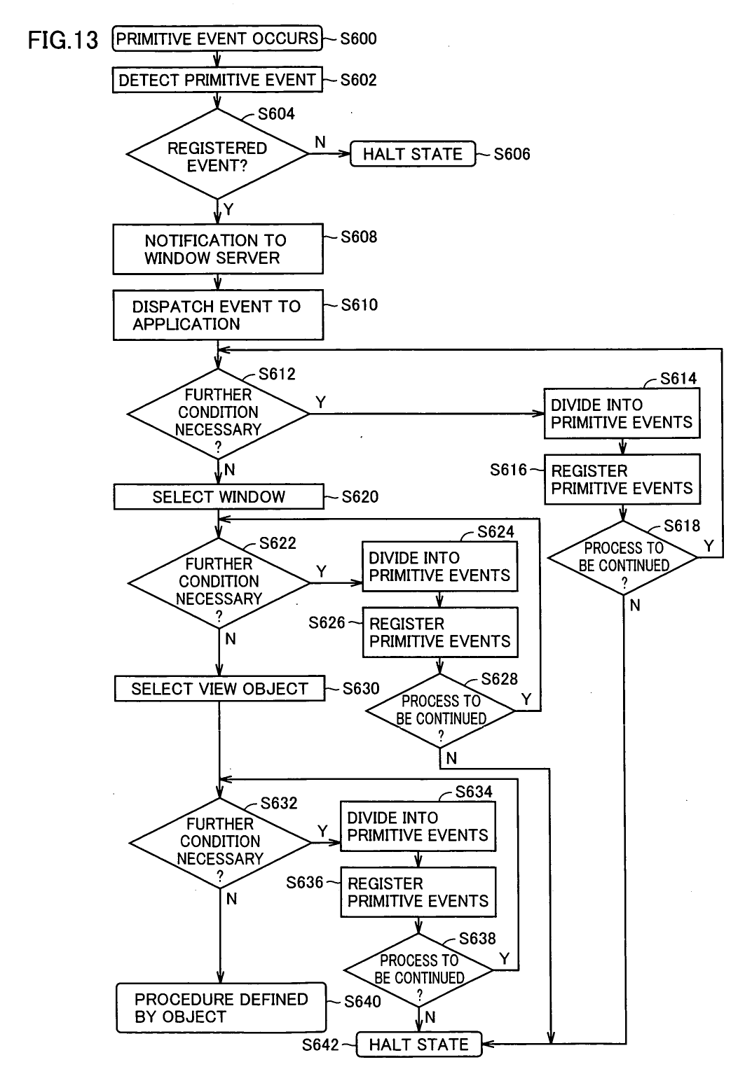

FIG. 13 is a flow chart representing a flow of a UI event processing in accordance with the third embodiment.

Referring to FIG. 13, when a primitive event that has been registered in registering portion 113 in event notification portion 110 is fired (step S600), the event is detected by detecting portion 111 in event notification portion 110 in step 5602. Then, the flow makes a transition to step S604 in which whether the detected event has been registered in registering portion 113 or not is determined. When the event is identified as the registered event, the flow makes a transition to step S608, and otherwise, the flow makes a transition directly to a halt state (step S606).

In step S604, when the event has been registered, the fact is notified to window server 161.

Based on application information managed by a table in application management processing portion 162 in application management portion 160, an application as a dispatch destination is determined by window server 161 (step S610). At this time, if another event is necessary for processing the application object (steps S612), for example, if a different process should be performed five seconds after activation of the application, the necessary event is divided as a combination of primitive events (step S614), and the event is registered in a format that allows processing by registering portion 113 (in step S616). The event registering process is realized by a framework of a common object procedure. First, in step S618, whether the process is to be continued or not is determined, and if it is necessary to perform only a registration of an event to be activated next and continuous processing is unnecessary, the process enters a halt state (step S642). If it is possible to continuously perform processes, a different event condition is checked again in step S612. If additional event registration is unnecessary and parallel processing is possible, selection of a window object is performed continuously (step S620).

As for the processing of window object, the process of additional event registration is done in the same framework of common object procedure. Specifically, when it is necessary to activate another event for processing the window object (step S622), the necessary event is divided into combinations of primitive events (step S624), and the event is registered in a format that can be processed by registering portion 113 (step S626). In step S628, whether the process is to be continued or not is determined. If the continuous processing can not be executed as in the case where only the registration of the event to be activated next is necessary, the process enters the halt state (step S642), and if continuous processing is possible, whether there is a different event condition or not is checked again in step S622. If additional event registration is unnecessary and parallel processing is possible, selection of a view object is performed continuously (step S630). Here again, as for the processing of view object, the process of additional event registration is done in the same framework of common object procedure. Specifically, when it is necessary to activate another event for processing the view object (step S632), the necessary event is divided into combinations of primitive events (step S634), and the event is registered in a format that can be processed by registering portion 113 (step S636). In step S638, whether the process is to be continued or not is determined. If the continuous processing can not be executed as in the case where only the registration of the event to be activated is necessary, the process enters the halt state (step S642), and if continuous processing is possible, whether there is a different event condition or not is checked again in step S632. If additional event registration is unnecessary and parallel processing is possible, a procedure defined by the object is continuously performed (steps S640).

In this manner, a scheme for changing application behavior, for closing only a certain panel, or for changing only a certain UI component, can be realized in one same framework.

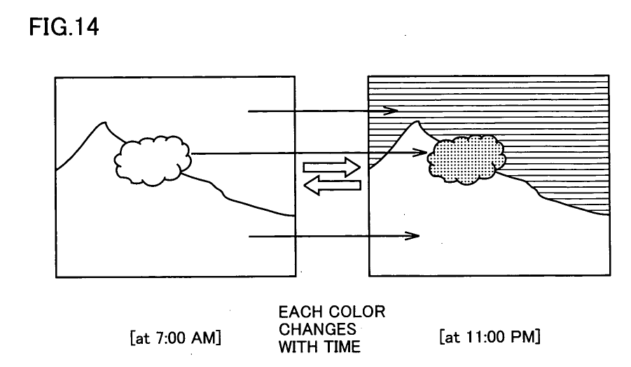

FIG. 14 is an exemplary illustration showing a display of contents (images) that changes with time, in which a drawing pattern of display color of a landscape image object is given by the time information. The exemplary image contents shown in FIG. 14 consist of background/cloud/mountain, and constrained condition related to time is imposed on each element.

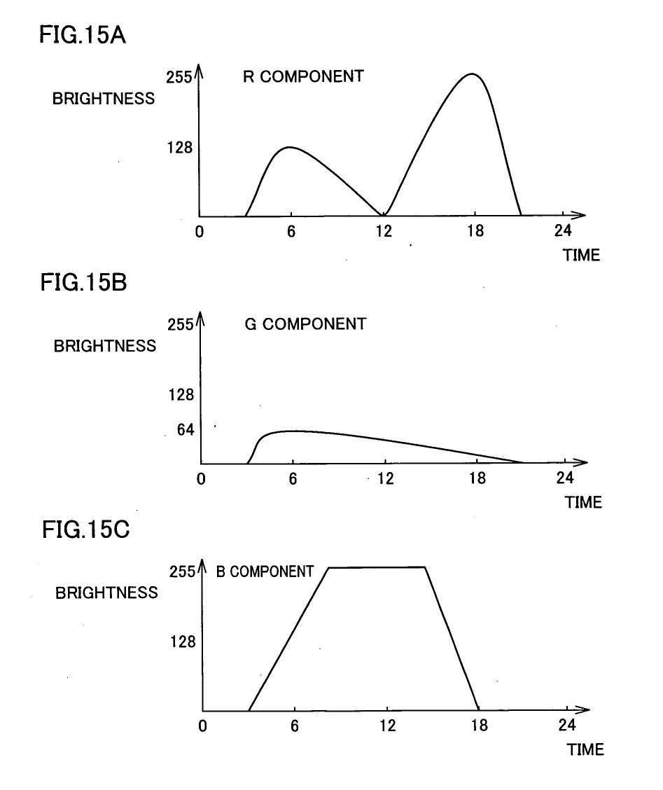

FIGS. 15A to 15C represent a time-dependent function that defines display of each element when the contents of FIG. 14 are to be displayed, in which RGB levels constituting color information of respective elements of the contents are defined in the form of functions dependent on time t. Specifically, functions are prepared for R, G and B components, respectively, and the values of R, G and B as color signals necessary for display contents are determined as function values, and respective elements of the contents change in accordance with time information.

The patterns are defined as a function to represent continuous transition of color, from mildly reddish sunrise glow in the morning, gradually increased blue component in the day time, sunset glow of orange to gradually darkening red in the evening and dark night, and the display is changed in accordance with given time information. Thus, the display of contents can be changed with time. The change in display of contents may be dependent on the time of activation of the viewer application, or the display may be changed automatically dependent on time. The former approach can be realized by deciding portion 121 applying time information, in the configuration shown in the block diagram of FIG. 1. As for the latter approach, in order to continuously change the display of contents, in the information processing apparatus implemented as shown in the functional block diagram of FIGS. 8 and 11, the timing of determining object processing is scheduled by the event-driven algorithm shown in FIG. 10, and thus the approach is realized.

When this is applied to a UI component, it becomes possible to change the display of a specific UI with time. The present invention is not limited to the example described above, and generally applicable to an information processing apparatus having such a configuration in that data element is determined in the form of a time-dependent function.

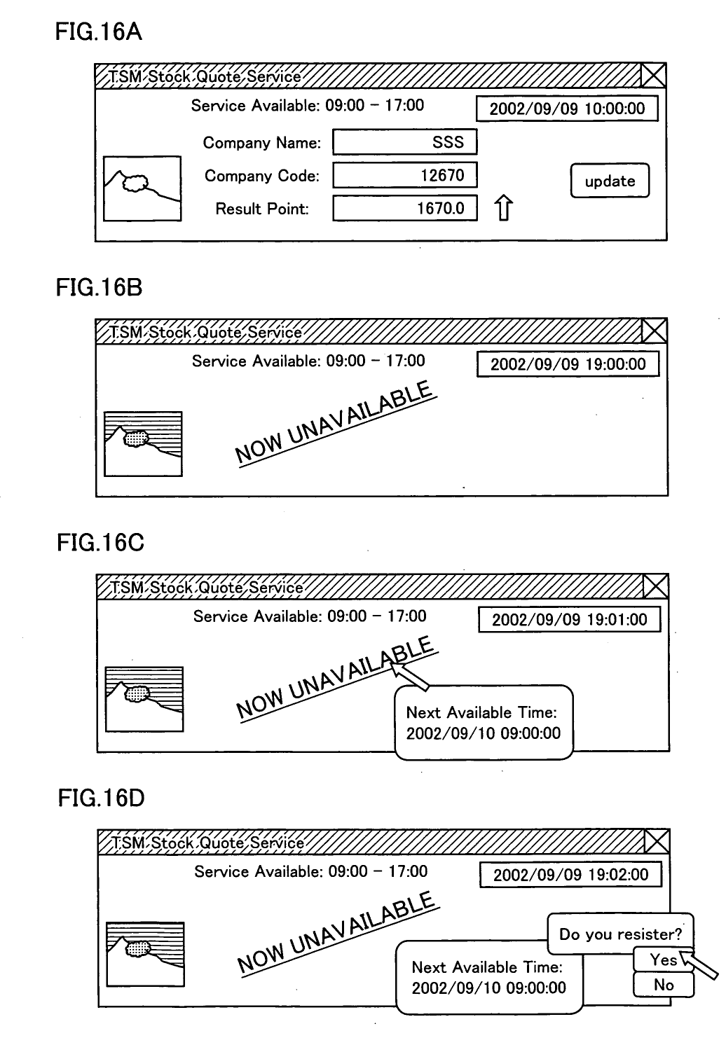

FIGS. 16A to 16D represent exemplary display and operation of a network service, showing a model of which display changes dependent on whether the service is available or not, as determined by the time of activation.

FIG. 16A shows an exemplary display image presented to the user when the user accesses to the network service while the service is available, and here the service is, by way of example, Stock Quote Service. When the service is used in the service available time, the stock price at the time of application is displayed. An image of contents arranged on a lower left portion has its display changed with time (FIG. 14). In the normal service open hours, an image showing bright sky of daytime is displayed, to show that the service is available. In a box arranged at an upper right portion, present time is displayed, to help better understand the present example.

FIG. 16B shows an exemplary display image given in response to an access made when the service is not available. As an image presented to the user, a display is given notifying that the service is unavailable, and in addition, the image (night image) of contents displayed at the lower left portion indicates to the user that it is out of service hours.

FIG. 16C shows an example in which, as user moves a pointer to a display indicating that it is a time when service is unavailable, the time when the service becomes available is displayed as a supplementary information to the user. Typical information generally defined as objects for providing a service includes an argument sequence necessary to receive the service itself, an access pointer (URI) thereof and effective time. Information supplementing portion 126 refers to management processing portion 104 for information of the related object, whereby time information as to when the service becomes available next is obtained, and the supplementary information is presented to the user. This enables presentation of information more convenient for the user.

Further developed from FIG. 16C presenting as supplementary information that it is the time when the service is unavailable, FIG. 16D shows an exemplary setting that allows immediate issuance of a service request when the time comes, by registering as an event the timing at which the service becomes available. Information supplementing portion 126 refers to management processing portion 104 for the information of related object, obtains time information as to when the service becomes available next, and in the course of presenting supplemental information to the user, proposes to the user that the user makes event registration to enable immediate service when the service becomes available next time. Here, through information management portion 104, event registration related to the corresponding service object is conducted.

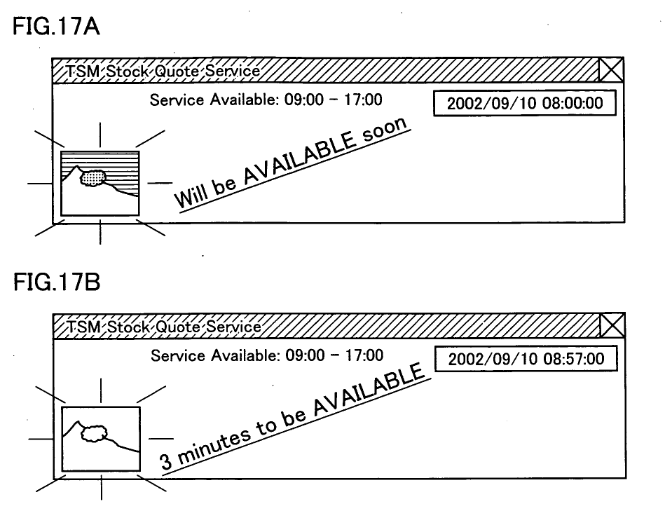

FIGS. 17A and 17B show examples of display and operation of the network service, representing a model in which the display changes when the service is not available at the time of activation.

FIG. 17A shows an example when the service start time is drawing near. Information supplementing portion 126 refers to information management portion 104 for the information of related object, and determines a timing at which the service becomes available. When the remaining time until the service is activated next becomes lower than the threshold value held/managed in information supplementing portion 126, a display is given notifying that the service will be available soon. Further, as the image of contents at the lower left portion, an animation starts, indicating to the user that the timing at which the service becomes available will come soon. In relation to the operation of changing the image of contents or character display, an approach may be possible in which information management portion 104 separately defines the timing when the display is to be changed next.

FIG. 17B shows an example when the service start time is drawing near, in which the image of contents at the lower left portion indicates, by an animation showing the sky starts to grow light, that the service available time is drawing near, and the remaining time until the service starts is displayed on the screen. Though the display or operation reflecting the availability may be immediately given at the time when the service actually becomes available, such an approach is not sufficiently convenient, and an advanced notice is advantageous to the user.

[Fourth Embodiment]

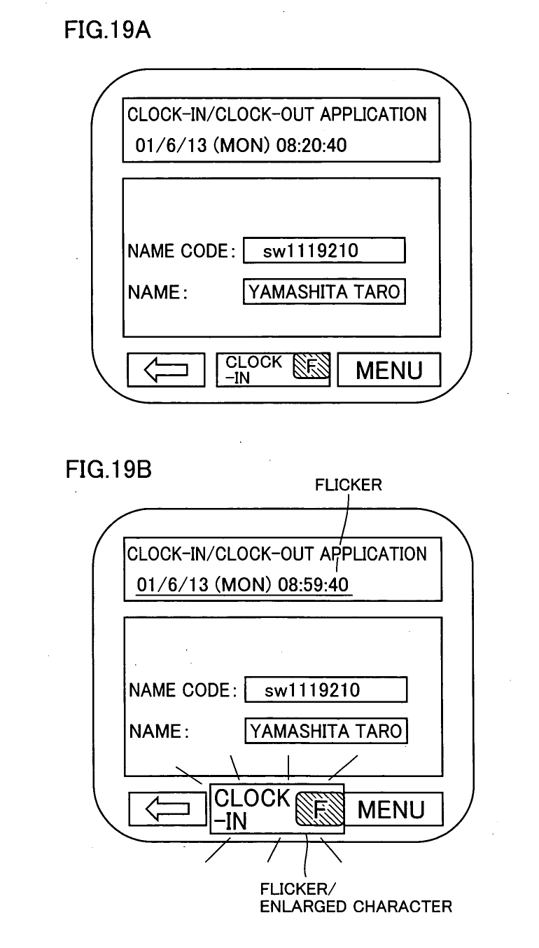

Another embodiment implemented by information processing apparatus 300 shown in FIG. 11 will be described with reference to FIGS. 19A and 19B.

FIGS. 19A and 19B show an example in which time information is applied when a program (object) operating on a portable telephone is used, whereby contents of display and operation change. The application as a base of the display shown in FIGS. 19A and 19B is an application enabling clock-in and clock-out management by a portable telephone.

FIG. 19A shows an example of the clock-in/clock-out application around the office start hour in the morning. The present time, at which the application is activated, is displayed in real time at an upper portion of 19. At the middle portion, the name of a person whose clock-in and clock-out are to be registered and its code number are input as authentication information (these are assumed to be input automatically to the portable telephone, by initially carrying out a registering process). At a lower portion, operation contents in one-to-one mapping with device keys are displayed. Here, operations are assigned such that the left key on the screen corresponds to “cancel”, F key corresponds to “clock-in registration” and the right key corresponds to “return to menu.” In the following, it is assumed that office hours start at 9:00. The timing of display of FIG. 19A is 8:20 in the morning, and based on this information of current time, in determining portion 120, deciding portion 121 selects and decides clock-in process as the operation assigned to the F key, as the process by executing portion 130, the format of messaging and data to be transmitted to an external server for clock-in registration are defined for the F key, and the key function display to the user is changed (external network configuration including the server required as a destination of transmitting the message is not described). When the user presses the F key at the timing shown in FIG. 19A, the clock-in registration process is done by communication to the external server.

By making a reference to the expiration period of services dependent on the clock-in/clock-out service, operations and displays assigned to the keys can adaptively be changed. This is advantageous in that, by way of example, resources can be effectively used as the key assignment can adaptively be changed in a device such as a portable telephone. In addition, it is one effective method realizing simplicity and visibility of operations for a topic that tends to make operations complicated, as to which specific function can be realized by which key or which combination of keys. Further, there is an additional effect that the amount of traffic and data to be actually transmitted can be reduced, because as much processes as can be done in the portable telephone device are done in the device.

FIG. 19B shows an example of the clock-in/clock-out application around the office start hour in the morning, when it is very close to the start time of 9:00. The time displayed in FIG. 19B is 8:59:40, and here, the present time arranged at the upper portion flickers, and the information related to the function of F key at the lower portion is displayed in enlargement. The change in display is effective to attract attention of the user and to urge operation. The change in display may be realized by registering the same in the form of a time event in advance in event notification portion 110, as information supplementing portion 126 changes the display in event-driven manner based on the registered event. The timing at which flickering starts or the interval of flickering, as well as the level of enlarging/reducing character must be defined beforehand as dependent on the application, in the process of the object separately. By registering the activation timing as an event, it can be realized in a manner independent from the system implementation. Further, it is also possible to attract attention of the user by an animation display, instead of flickering.

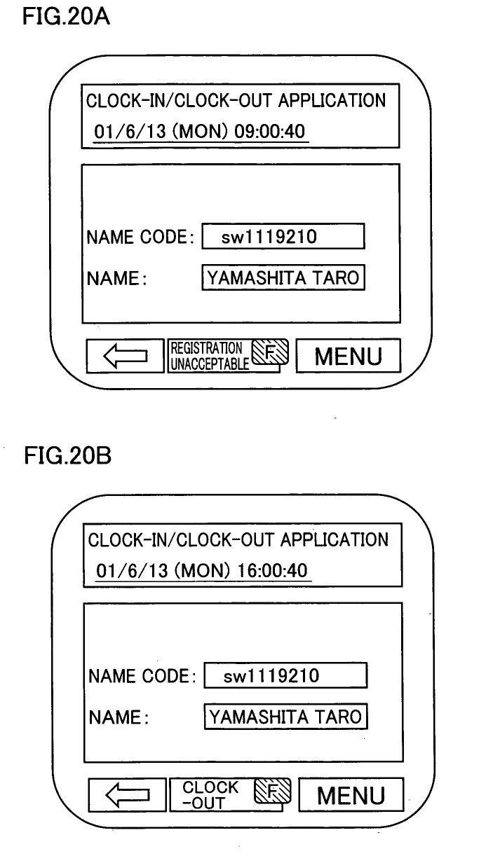

FIGS. 20A and 20B show further examples of the images of clock-in/clock-out application.

FIG. 20A shows an exemplary image when the business start time has passed, and FIG. 20B shows an exemplary image in the evening.

The time displayed in FIG. 20A is later than the business start time, and with reference to the time information, it is determined that the service is unavailable. Thus, the processes assigned to the F key, including the clock-in registration process and display assigned to the F key, are changed in an event-driven manner.

In the example of FIG. 20B, the time is in the evening, and therefore, a clock-out registering process is assigned to the F key, and the display to the user is also changed. At which timing the display and operations are to be changed differs application by application. Such change can be realized by a comprehensive mechanism when defined in an event-registration format, or by a system fixedly defining the timing of decision in advance. Information processing apparatus 300, the program for executing such a process and a UI apparatus realized by a medium recording the program realize a mechanism of providing information in an adaptive manner, in which the user operation is optimally adapted to the time of operation.

Specifically, a process in which a UI display changes with time, or a process in which a method of UI operation changes with time becomes possible. In this respect, the direct mapping to the operation can be changed and, in addition, indirect mapping to the operation can be changed, such that a key pressing operation or a single-click operation of a mouse may be regarded the same as a double-click operation of the mouse at a certain time. Further, a process in which display appears more slowly or characters are flickered at a higher rate as the designated time comes closer is also possible. In addition, as a part of general UI outputs, voice can be handled. Dependent on the time of activation, a pre-registered voice may be output, or adaptive voice output process may be performed in accordance with time information in an event-driven manner. When an output pattern is defined as a time-variable object, output frequency can be changed in accordance with time. Further, it is possible to apply the process to a portable telephone to register or set the ringing tone in advance, to be changed in accordance with time. By way of example, at every few hours in a day, or at a certain time period from 4:00 to 5:00, for example, the ringing tone of a call from a certain caller may be changed. As a specific example of this application, the ringing tone may be given with the volume lowered at night.

Information processing apparatus 300, the program for executing such a process and a UI apparatus realized by a medium recording the program make an adaptive interaction between the user and the system possible, when the UI component is realized as an object including time information in its element or procedure, as the characteristic of the UI is changed based on the time information. This includes a change in display of the UI component with time, and a change in meaning of a user operation assigned to the UI component.

Further, a presentation type information processing is possible, in which the change in specific contents of the element or procedure related to the object processing is notified to the user at the timing of change.

Further, by presenting notification related to the change in specific contents of the element or procedure of the object at a timing earlier than the actual object processing, it becomes possible, when a shape of an object arranged on a screen is to be actually changed, to attract attention of the user, by flickering a prescribed time before the actual change. Further, notification such as “operation contents will be changed in . . . seconds” may be given as a display image output or voice output. In addition, when an UI component is realized as a time-constrained object, a UI element of which display or operation contents change with time can be realized and at the timing of change, an animation process may be inserted to effectively notify the user about the change.

Further, such a manner of use is possible that the timings of determining object processing are scheduled beforehand, and therefore, a time-event-driven type UI component and UI system can be realized in which meaning of a display or an operation is changed at a certain time point in a sort of automatic manner without any explicit instruction or action by the user.

Further, information processing apparatus 300 and the method of the present invention can be built by a general purpose computer. At that time, determining portion 120, executing portion 130, object management portion 101 and event notification portion 110 are implemented on a computer, and their functions are realized by executing an information processing program. The control program may be introduced to an external storage device such as a removable disk, flash memory, floppy (R) disk or a memory card. Therefore, the present invention encompasses a recording medium recording an information processing program that can be executed on a computer.

Although the present invention has been described and illustrated in detail, it is clearly understood that the same is by way of illustration and example only and is not to be taken by way of limitation, the spirit and scope of the present invention being limited only by the terms of the appended claims.

1. An information processing apparatus, comprising:
determining means for performing, on an object of which element or procedure can be described based at least on information related to time, a process based on time information for determining an element or procedure of said object;
executing means for executing a process based on contents of the process determined by said determining means; and
object management means storing said object for managing its operation and status; wherein
in the object to be processed by said information processing apparatus, different time-restricting condition may be imposed on every uniquely identifiable element or procedure defined in the object, and
said determining means selects an appropriate process at a timing of applying the time information.

2. The information processing apparatus according to claim 1, further comprising
event notification means registering and holding an event condition based on external information, for notifying said object management means about an event that occurs when the condition is satisfied; wherein
said event notification means and said object management means each include interface means for performing an event input/output operation; and
said executing means changes the process in an event-driven manner in response to said event input/output operation.

3. The information processing apparatus according to claim 1, wherein
said determining means has object generating means for newly generating, after determination of a process related to specific contents of the element or procedure of the object by applying time information, an object based on the result of determination; and
said executing means performs a process based on said generated object.

4. The information processing apparatus according to claim 1, wherein
in the object to be processed by said information processing apparatus, a plurality of contents of elements and procedures of said object are prepared, said plurality of contents of elements and procedures are fully contained in said object as a single object, and contents are selectively determined by processing the time information.

5. The information processing apparatus according to claim 1, wherein
in the object to be processed by said information processing apparatus, contents of an element or procedure of said object can be described in a format of external reference; and
in determining contents of an element or procedure of an object, when any item requires external reference for resolution, said determining means requests said object management means for the resolution and determines the contents of processing.

6. The information processing apparatus according of claim 5, wherein
said object management means has
storing means,
searching means for searching for an object stored in a storage area of said storing means, and
communication means for obtaining information through a network, and
in response to a request from said determining means, searches and obtains necessary information under control or through the network, and notifies said determining means about the contents, whereby the item requiring external reference is resolved and the contents of processing are determined.

7. The information processing apparatus according to claim 1, wherein
the object to be processed by said information processing apparatus has such a format of representation that a specific value or method related to its element or procedure is determined for the first time when said determining means applies the time information.

8. The information processing apparatus according to claim 1, wherein
when said determining means applies time of activation, the object to be processed by said information processing apparatus has a data value or method related to its element or procedure determined.

9. The information processing apparatus according to claim 1, wherein
when the determining means applies virtual time of activation, the object to be processed by said information processing apparatus has a data value or method related to its element or procedure, based on the condition, adapted and determined.

10. The information processing apparatus according to claim 9, wherein
the object to be processed by said information processing apparatus has contents of its element or procedure described in a form of a time-related function, and when said determining means applies the time information, a data value or method related to its element or procedure is determined.

11. (canceled)

12. The information processing apparatus according to claim 1, wherein
in the object to be processed by said information processing apparatus, description simultaneously including descriptions based on a plurality of time constraints may be made as long as there is no time crossing, on every uniquely identifiable element or procedure defined in the object; and
said determining means selects an appropriate process at a timing of applying the time information.

13. The information processing apparatus according to claim 1, wherein
time constraint related to an element or procedure defined in the object to be processed by the information processing apparatus is described as a condition of invalidating the corresponding element or procedure.

14. The information processing apparatus according to claim 1, wherein
in determining contents of an element or procedure related to the object to be processed, when there is no item that satisfies a time constraint, said determining means makes a notification to said object management means and any process related to said object thereafter is stopped.

15. The information processing apparatus according to claim 1, wherein
in determining contents of an element or procedure related to the object to be processed, when there is no item that satisfies a time related condition, said determining means makes a notification to said object management means and executes a process based on an object appropriately selected by said object management means.

16. The information processing apparatus according to claim 12, wherein
some of the time constraints imposed on the element or procedure defined in the object to be processed by said information processing apparatus may mixedly include descriptions in accordance with different scale designations; and
said determining means includes means for selecting an actual process by mapping time constraint scales imposed on the element or procedure of the object to a single time axis.

17. The information processing apparatus according to claim 12, wherein
some of the time constraints imposed on the element or procedure defined in the object to be processed by said information processing apparatus may mixedly include descriptions in accordance with different- methods of designation including absolute time designation, relative time designation or interval designation; and
said determining means includes means for selecting an actual process by using a predetermined priority with respect to descriptions of time constraints imposed on the element or procedure of said object.

18. The information processing apparatus according to claim 5, wherein
when the object to be processed by said information processing apparatus is generated from an arbitrary time-constrained object as a parent, the object inherits characteristics related to the element and procedure defined in the parent object as well as time constraint imposed on each of the element and procedure.

19. The information processing apparatus according to claim 18, wherein
the object to be processed by said information processing apparatus inherits each said time constraint related to the element and procedure defined by said parent object, and when a process related to the corresponding element and procedure is to be overridden, asks the parent object for delegation of authority to obtain permission of execution.

20. The information processing apparatus according to claim 18, wherein
the object to be processed by said information processing apparatus individually inherits or refers to only the time constraint related to each of the element and procedure defined by said parent object, whereby a process dependent on a part of a process of said parent object is described.

21. The information processing apparatus according to claim 20, wherein
the object to be processed by said information processing apparatus asks said parent object for permission, when it individually inherits or refers to only the time constraint related to each of the element and procedure defined by said parent object.

22. The information processing apparatus according to any of claims 19 to 21, wherein
the object to be processed by said information processing apparatus operates a timing of linked processing among objects, by re-arranging, through an off-set designation, time constraints related to the element and procedure defined by said parent object.

23. The information processing apparatus according to claim 1, wherein
said executing means has information presenting means for presenting to the user, at a timing of switching of a process based on contents of an element or procedure of the object determined by said determining means, information related to a change in the process, and
at a timing when object behavior changes with time, presents information related to the change in the object behavior to the user.

24. The information processing means according to claim 2, wherein
said object management means registers a timing of determining contents of the element or procedure related to the object by the determining means in the event notification means beforehand, to perform scheduling of the timings of determining operations thereafter.

25. The information processing apparatus according to claim 24, wherein
said object management means has registering means for registering the timing of determining contents of the element or procedure related to the object by said determining means in the event notification means to cause event firing at a timing earlier than a defined time; and
after receiving an event from said event notification means, earlier than a timing when contents of the element or procedure are changed by said determining means, information related to a change in behavior of said object is presented to the user.

26. The information processing apparatus according to claim 7, wherein
the object to be processed by said information processing apparatus realizes a user interface, and a method of displaying a component is changed in accordance with applied time information.

27. The information processing apparatus according to claim 7, wherein
the object to be processed by said information processing apparatus realizes a user interface, and
a method of operation assigned to said component is changed in accordance with applied time information.

28. The information processing apparatus according to claim 27, wherein
the object to be processed by said information processing apparatus realizes a user interface, and
at a timing when object behavior changes with time, the change in said object behavior is presented to the user by changing a component display through animation.

29. The information processing apparatus according to claim 1, comprising
means for performing information processing involving an object of which element or procedure can be described based on time information and an object not dependent on time information.

30. An information processing method, comprising the steps of:
determining, on an object of which element or procedure can be described at least on information related to time, contents of the element or procedure of the object based on time information;
performing information processing based on the determined contents of processing; and
performing adaptive information processing, by storing said object, managing operation and status, and changing contents of the element or procedure described in the object based on the time information; wherein
in the object to be processed by said information processing apparatus, different time-restricting condition may be imposed on every uniquely identifiable element or procedure defined in the object, and
said determining step includes the step of selecting an appropriate process at a timing of applying the time information.

31. An information processing program, causing a computer to execute the steps of:
determining, on an object of which element or procedure can be described at least on information related to time, contents of the element or procedure of the object based on time information;
performing information processing based on the determined contents of processing; and
performing adaptive information processing, by storing said object, managing operation and status, and changing contents of the element or procedure described in the object based on the time information; wherein
in the object to be processed by said information processing apparatus, different time-restricting condition may be imposed on every uniquely identifiable element or procedure defined in the object, and
said determining step includes the step of selecting an appropriate process at a timing of applying the time information.

32. A computer readable recording medium, recording an information processing program causing a computer to execute the steps of:
determining, on an object of which element or procedure can be described at least on information related to time, contents of the element or procedure of the object based on time information;
performing information processing based on the determined contents of processing; and
performing adaptive information processing, by storing said object, managing operation and status, and changing contents of the element or procedure described in the object based on the time information; wherein
in the object to be processed by said information processing apparatus, different time-restricting condition may be imposed on every uniquely identifiable element or procedure defined in the object, and
said determining step includes the step of selecting an appropriate process at a timing of applying the time information.
